(19) United States
(12) Patent Application Publication
(10) Pub. No.: US 2026/0155640 A1
(43) Pub. Date: Jun. 4, 2026

(54) Flush-Mounted Module with Reduced Dimensions for Flush Mounting in a Wall, Floor Socket or Piece of Furniture and Method for Flush Mounting Thereof

(71) Applicant: Shiver NV, Veurne (BE)

(72) Inventor: Thibault Renson, Veurne (BE)

(21) Appl. No.: 19/455,804

(22) Filed: Jan. 21, 2026

Related U.S. Application Data
(63) Continuation of application No. PCT/EP2024/054204, filed on Feb. 19, 2024.

(30) Foreign Application Priority Data
Jul. 31, 2023 (BE) BE2023/5635
Nov. 15, 2023 (WO) PCT/IB2023/061571
Jan. 26, 2024 (WO) PCT/EP2024/051995

(51) Int. Cl. H02G 3/12

(52) U.S. Cl. CPC H02G 3/12

(57) ABSTRACT

The current invention relates to a flush-mounted module, comprising a housing and a socket, the housing comprising a hollow body with a front wall, back wall and one or more side walls, a flange extending away from the body, at least one clamp for clamping the flush-mounted module, and a clamp screw through each of the at least one clamps, where the socket is attached behind the front wall, wherein after perpendicular projection onto the plane formed by the front wall, a center point of the clamp screw lies within a smallest possible polygon around an enveloping outline of a smallest possible insulation surface around contact points of the socket, wherein an enveloping outline is a smallest possible circle in the plane formed by the front wall around the smallest possible insulation surface. The invention also relates to a method and a use.

### CROSS-REFERENCE TO RELATED APPLICATIONS

This application is a continuation of PCT/EP2024/054204 filed Feb. 19, 2024, which claims priority to Belgian Patent App. No. BE2023/5635 filed Jul. 31, 2023, PCT/IB2023/061571 filed Nov. 15, 2023, and PCT/EP2024/051995 filed Jan. 26, 2024, the disclosures of which are hereby incorporated by reference.

### TECHNICAL FIELD

The invention relates to a flush-mounted module for incorporation of a socket in a wall, floor socket or a piece of furniture, more in particular a flush-mounted module with reduced dimensions. The invention also relates to a method for incorporating the flush-mounted module in a wall, floor socket or piece of furniture and a use of the flush-mounted module and/or the method for incorporation of a socket in a wall, floor socket or piece of furniture.

### PRIOR ART

An electrical system in a building today is very extensive. Sockets are ubiquitous. While these sockets used to be almost exclusively installed in or on brick or concrete walls, they are now also regularly installed in thin walls or furniture. Specific flush-mounted boxes with clamps and clamp screws are available for this purpose. A hole is drilled in the wall or piece of furniture with a hole saw or a hole is provided in a floor socket. The flush-mounted box is placed in the hole, after which the clamps move by tightening the clamp screws and the flush-mounted box is clamped in the hole. Electrical wiring is led to the flush-mounted box and connected to the socket. The socket is then placed inside the flush-mounted box.

Such flush-mounted boxes are known from, among others, ES188370U and U.S. Pat. No. 9,627,870. These well-known flush-mounted boxes have the disadvantage that it takes a lot of time to install a socket. Not only must the flush-mounted box be installed, but the socket must also be connected and placed in the flush-mounted box. An additional disadvantage is that the clamps must be able to be moved very close to an open front side of the flush-mounted box, so that the flush-mounted boxes can also be secured in thin walls, such as plasterboard with a thickness of 9 mm. This means that the clamp screws must extend almost to the open front side. The active part of the socket also extends to the open front side. The clamp screws therefore necessarily extend next to the functional part of the socket. This makes the flush-mounted box larger than strictly necessary to accommodate the socket. Open space between the flush-mounted box and the socket is then covered by a cover frame with an opening for the active part of the socket. The cover frame is an extra part that must be installed and provides an extra step when flush mounting the socket. Very often, the cover frame makes the surface area required for flush mounting a socket even larger, which unnecessarily limits installation options in a wall or in a piece of furniture.

The present invention aims to solve at least some of the above problems or drawbacks.

### SUMMARY OF THE INVENTION

In a first aspect, the present invention relates to a flush-mounted module.

This flush-mounted module is advantageous because a socket can be built into a wall or piece, floor socket of furniture in fewer steps, using a single flush-mounted module. The flush-mounted module only needs to be connected and installed. A flush-mounted box is unnecessary. It is particularly advantageous that the center point of the clamp screw of the at least one clamp lies within a smallest possible polygon around an enveloping outline of the smallest possible insulation surface around the contact points of the socket. Regulations prescribe a minimum insulation surface around the contact points for each type of socket. The enveloping outline of the smallest possible insulation surface around the contact points therefore corresponds to the smallest possible bore diameter for installing a socket in a wall, floor socket or piece of furniture. If an even smaller hole is drilled or is provided in the floor socket, it will not be possible to install the socket in the wall, floor socket or piece of furniture. In that case, the minimum insulation surface of the socket hits the wall, floor socket or piece of furniture. A polygon offers more freedom of form for the flush-mounted module. Because the center point of the clamp screw of the at least one clamp lies within the polygon, the flush-mounted module has much more limited dimensions compared to a combination of a flush-mounted box with a socket according to the prior art.

Preferred forms of the flush-mounted module are disclosed herein.

A specific preferred form concerns a flush-mounted module.

The front wall advantageously conceals the clamp screw of the at least one clamp, so that the clamp screws are not directly accessible after incorporation of the flush-mounted module and the flush-mounted module cannot be easily removed from a wall or from a piece of furniture. Because the front wall is removable, it is still possible to remove the flush-mounted module from the wall, the floor socket or piece of furniture in the event of replacement.

In a second aspect, the present invention concerns a method.

This method has the advantage that a socket can be built into a wall, floor socket or piece of furniture in fewer steps, using a single module. The flush-mounted module only needs to be connected and installed. It is particularly advantageous that less surface area is required for installing the socket, which means there are more installation options for installing the socket in the wall or in the piece of furniture.

A preferred form of the method is disclosed herein.

In a third aspect, the present invention relates to a use.

This use results in an advantageous flush mounting of a socket with minimal visual impact. Because the center point of the clamp screw of the at least one clamp lies within a smallest possible polygon around an enveloping outline of the smallest possible insulation surface around the contact points of the socket, the flush-mounted module has minimal dimensions. Due to a minimal thickness of the flange or of the part of the front wall that lies on the flange, it is possible to provide a recess in the wall or in the piece of furniture to this end, allowing the socket to be recessed into the wall, floor socket or piece of furniture. Due to the flush mounting of the socket in the wall, floor socket or piece of furniture in combination with the minimum dimensions of the flush-mounted module, it appears as if the wall, floor or piece of furniture runs flush. The wall, floor socket or piece of furniture is only visually disturbed to a very minimal extent.

### DESCRIPTION OF THE FIGURES

FIGS. 1A-ID show a front view, a front view without a front wall, a side view and a rear view of a flush-mounted module according to an embodiment of the current invention with a type E socket.

FIG. 2 shows an exploded view of the flush-mounted module from FIGS. 1A-1D.

FIGS. 3A-3D show a front view, a front view without a front wall, a side view and a rear view of a flush-mounted module according to an embodiment of the current invention with a type F socket.

FIG. 4 shows an exploded view of the flush-mounted module from FIGS. 3A-3D.

FIGS. 5A-5D show a front view, a front view without a front wall, a side view and a rear view of a flush-mounted module according to an embodiment of the current invention with a type G socket.

FIG. 6 shows an exploded view of the flush-mounted module from FIGS. 5A-5D.

FIGS. 7A-7D show a front view, a front view without a front wall, a side view and a rear view of a flush-mounted module according to an alternative embodiment of the present invention with a type G socket.

FIG. 8 shows an exploded view of the flush-mounted module from FIGS. 7A-7D.

FIGS. 9A-9D show a front view, a front view without a front wall, a side view and a rear view of a flush-mounted module according to an embodiment of the current invention with a type B socket.

FIG. 10 shows an exploded view of the flush-mounted module from FIGS. 9A-9D.

FIG. 11 shows a front view of a flush-mounted module according to an alternative embodiment of the current invention with a type B socket.

FIG. 12 shows a cross-section of a flush-mounted module according to an embodiment of the current invention, wherein the flush-mounted module is placed in a wall with the aid of a mounting plate.

FIG. 13 shows a cross-section of a flush-mounted module according to an alternative embodiment of the current invention, wherein the flush-mounted module is placed in a wall with the aid of a mounting plate and wherein a releasable ring is clamped between the wall and a flange of the flush-mounted module.

FIG. 14A-14G shows a front view, a front view without a front wall, a side view, a top view, a perspective view, a perspective view without a front wall, and a perspective rear view of a flush-mounted module according to an embodiment of the current invention with two type B sockets in a horizontal arrangement.

FIG. 15A-15C shows a front view, a perspective view, and a perspective view without a front wall of a flush-mounted module according to an embodiment of the current invention with two type B sockets in a vertical arrangement.

FIG. 16A-16G shows a front view, a front view without a front wall, a side view, a top view, a perspective view, a perspective view without a front wall, and a perspective rear view of a flush-mounted module according to an embodiment of the current invention with two type B sockets in a horizontal arrangement.

FIG. 17A-17C shows a front view, a perspective view, and a perspective view without a front wall of a flush-mounted module according to an embodiment of the current invention with two type B sockets in a vertical arrangement.

FIG. 18A-18F shows a front view, a front view without a front wall, a side view, a perspective view, a perspective view without a front wall, and a perspective rear view of a flush-mounted module according to an embodiment of the current invention with three type B sockets in a horizontal arrangement.

FIG. 19 shows a front view of a flush-mounted module according to an embodiment of the current invention with two type B sockets and a USB-port in horizontal arrangement.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

The terms “comprise”, “comprising”, “consist of”, “consisting of”, “provided with”, “include”, “including”, “contain”, “containing”, are synonyms and are inclusive or open terms that indicate the presence of what follows, and which do not exclude or prevent the presence of other components, characteristics, elements, members, steps, as known from or disclosed in the prior art.

Quoting numeric intervals by the endpoints includes all integers, fractions, and/or real numbers between the endpoints, including those endpoints.

In the context of this document, a visible surface is a surface that is visible after flush mounting a flush-mounted element in a wall, floor socket or piece of furniture.

In the context of this document, the functional part of a socket is the part that must be accessible to a person in order for the socket to fulfill its function.

In the context of this document, a cover frame is a plate or ring containing an opening for the functional part of a socket. After placement of the cover frame, in a flush-mounted box with a prior art socket, the functional part is located in the opening, with the cover frame connecting around the functional part in the opening.

In a flush-mounted box with a socket according to the prior art, the cover frame, after placement of the cover frame, covers clamp screws and any not yet covered provisions for removably attaching the socket in the flush-mounted box.

In the context of this document, concentric means that circles or a perpendicular projection of the circles onto the same plane, where the projected circles are also circles, have a common center, with outlines of the circles not touching or intersecting each other.

In the context of this document, a centerline is a line, imaginary or otherwise, that runs through the center of an object.

In the context of this document, an electrical installation is an interrelated set of electrical devices, connections and interconnections in a building.

In a first aspect, the invention concerns a flush-mounted module for installing a socket in walls or pieces of furniture.

The flush-mounted module comprises a housing and a socket.

The housing comprises a hollow body with a front wall, back wall and one or more side walls. The front wall, back wall and the one or more side walls connect to each other. The hollow body is, for example, substantially cylindrical, substantially beam-shaped, substantially a truncated conical shape or another suitable shape. The housing is preferably a plastic housing, more preferably a housing made of fire-retardant plastic.

The hollow body is preferably substantially cylindrical or substantially a truncated conical shape.

The housing comprises a flange on a side of the front wall. This means that the flange is located at or near an end of the hollow body, to which the front wall is closest. This does not rule out the possibility that the front wall is sunk into the hollow body. The flange extends away from the hollow body. This means that the front wall is not fully or partially covered by the flange. Preferably the flange extends in a direction parallel to the front wall. The flange is, for example, square, circular or another suitable shape. The flange is preferably circular. The flange preferably has a thickness of at most 1.5 mm, more preferably at most 1.0 mm and even more preferably at most 0.8 mm.

The hollow body can be placed in a cylindrical space up to the flange. This is advantageous because it allows the flush-mounted module to be easily installed by drilling or cutting out a hole in a wall or in a piece of furniture. The hole has a size that is smaller than the flange, so that the flush-mounted module cannot be pushed through the hole. It will be apparent that the cylindrical space is not necessarily a real space but can also be a virtual cylindrical space with a diameter equal to a diameter of the hole, which is available in a larger real space in a wall, floor socket or piece of furniture.

It is clear that the flange does not need to be present along a complete circumference of the hollow body. The flange could be partly present along the circumference. This is sufficient to avoid that the flush-mounted module can be pushed through the hole. Preferably parts of the flange are equally distributed along the circumference or present at two opposing sides of the hollow body. A flange that is only partly present along the circumference of the hollow body is advantageous for placing multiple flush-mounted modules adjacent to each other in a single hole.

It will be apparent that a beam-shaped body can be placed in the cylindrical space if a transverse cross-section of the beam-shaped body fits within a circular cross-section of the cylindrical space. It is also clear that a square flange is suitable for placing the hollow body in the cylindrical space, as long as the square flange is larger than the circular cross-section of the cylindrical space. Preferably, the entire circular cross-section of the cylindrical space fits within an outline of the square flange.

In further described embodiments, wherein the flush-mounted module comprises at least two sockets, the hollow body can be also be placed in a space up to the flange. However, the space is not necessarily cylindrical. The hole must still have a size that is smaller than the flange.

Also in case of a single socket, the hollow body can be placed in a space up to the flange that is not necessarily cylindrical. The space could be for instance beam-shaped and the hole could be a square or a rectangle.

A space that is beam-shaped, combined with a hole that is a square or rectangle is well suited for housing a hollow body that is for example substantially beam-shaped, especially in combination with a squared or rectangular flange.

The housing comprises at least one clamp for clamping the flush-mounted module in a wall or in a piece of furniture and a clamp screw through each of the at least one clamp. If the housing fits closely against the hole in the wall or in the piece of furniture after placement in the cylindrical space, one clamp is in principle sufficient to clamp the flush-mounted module in place. Preferably, the housing comprises at least two clamps. This is advantageous for firmly clamping the flush-mounted module in a wall or in a piece of furniture, even if, for example, the housing fits less closely against the hole in the wall or in the piece of furniture. The two clamps are preferably positioned opposite each other in the housing. If the housing comprises more than two clamps, the clamps are preferably regularly distributed over a circular outline.

It will be apparent that if a housing contains more than one clamp, “the at least one clamp” describes a feature that applies to all clamps for clamping the flush-mounted module. Thus, in the case where the housing includes two, three or more clamps, each of the two, three or more clamps includes a clamp screw through the clamp.

The clamp screw has a centerline. The centerline is along a longitudinal direction of the clamp screw. If the housing comprises two or more clamps, the centerlines of the clamp screws are preferably parallel. The at least one clamp includes an internally threaded opening. The clamp screw is screwed into the internally threaded opening.

The at least one clamp can be moved along the hollow body to a plane formed by the flange by screwing the clamp screw. A plane formed by the flange means a plane that extends infinitely, is parallel to the flange and where the flange lies in the said plane. For each of the at least one clamp, the housing comprises a guide for guiding the at least one clamp, wherein the guide extends in a direction transverse to the plane formed by the flange along the clamp screw of the at least one clamp. The guide is configured to prevent a rotational movement of the at least one clamp about the clamp screw when the clamp is in the guide. The guide preferably has a U-shaped cross-section in a plane parallel to the plane formed by the flange. When the at least one clamp is located in the guide, the at least one clamp cannot rotate around the clamp screw when tightening the clamp screw and screwing results in a translation of the at least one clamp towards the plane formed by the flange. This design of the at least one clamp is particularly suitable if the flush-mounted module is built into a thin wall or in a piece of furniture, where the at least one clamp is clamped against a rear side of the thin wall or against an inside of the piece of furniture.

Alternatively, the at least one clamp includes an axis of rotation parallel to the plane formed by the flange. The axis of rotation is a real axis or a virtual axis. The at least one clamp can be folded out by tightening the clamp screw, whereby the at least one clamp rotates around the axis of rotation and an end of the at least one clamp moves away from the housing. Preferably, the at least one clamp comprises barbs at the end. This alternative design of the at least one clamp is particularly suitable for clamping the flush-mounted module against a side wall of the cylindrical space, for example if a cylindrical space is drilled in a brick or concrete wall or a thick wall.

The socket is mounted behind the front wall in the housing. The socket is fixedly or removably mounted in the housing. The front wall shields live parts of the socket. The front wall forms the functional part of the socket. The socket is screwed, clicked or otherwise secured in the housing. The socket is attached to the front wall, the back wall, to one or more side walls or to a combination of the above in the housing. Preferably, the front wall, the back wall or both are removable so that the socket can be placed in the housing when the flush-mounted module is assembled. It will be apparent that if the front wall is removable, the back wall and the one or more side walls can be one piece and if the back wall is removable, the front wall and the one or more side walls can be one piece. The front wall includes openings to contact points of the socket. The openings are therefore intended for inserting a plug into the socket.

It is clear that in further described embodiments, wherein the flush-mounted module comprises at least two sockets, the front wall includes openings to contact points of the at least two sockets.

According to a preferred embodiment, a center point of the clamp screw of the at least one clamp, after perpendicular projection onto the plane formed by the flange, lies within an enveloping outline of a smallest possible insulation surface around the contact points of the socket. The clamp screw comprises a screw head. The center point of the clamp screw of the at least one clamp is a point on the screw head on the centerline of the clamp screw. The enveloping outline is a smallest possible circle in the plane formed by the flange around the smallest possible insulation surface. This means that a perpendicular projection of the smallest possible insulation surface on the plane formed by the flange falls within the enveloping outline. The perpendicular projection of the smallest possible insulation surface touches the enveloping outline at at least two points.

Regulations prescribe a minimum insulation surface around the contact points for each type of socket. The enveloping outline of the smallest possible insulation surface around the contact points therefore corresponds to the smallest possible bore diameter for installing a socket in a wall, floor socket or piece of furniture. If an even smaller hole is drilled, it will not be possible to install the socket in the wall, floor socket or piece of furniture. In that case, the minimum insulation surface of the socket hits the wall, floor socket or piece of furniture. Because the center point of the clamp screw of the at least one clamp lies within the enveloping outline, the flush-mounted module has much more limited dimensions compared to a combination of a flush-mounted box with a socket according to the prior art. Because the clamp screws of the at least one clamp lie within the enveloping outline, no cover frame is required. This means that even less surface area is required for installing a socket, which means there are more installation options than with a combination of a flush-mounted box with a prior art socket.

An example is installing several sockets next to each other in a porous stone wall. The multiple sockets are preferably placed in line at a center-to-center distance of no more than 80 mm from each other. For example, in Belgium, sockets are aligned horizontally at a center-to-center distance of 71 mm from each other and vertically aligned at a center-to-center distance of 60 mm from each other. In a porous stone it is essential that sufficient material remains between two drilled holes, so that the porous stone between the two drilled holes does not crack or break, which would require the wall to be replaced. Due to the much more limited dimensions of the flush-mounted module, more porous stone remains between the two drilled holes, which greatly reduces the risk of cracking or breakage.

In the screw head of the clamp screw of the at least one clamp there is a pattern for receiving a screwdriver. The clamp screw of the at least one clamp can be reached with a screwdriver through a recess in the socket. This means that at least the pattern in the screw head can be reached with the screwdriver through the recess. It is therefore possible to position the screw head lower than a front surface of the socket. The front surface of the socket means a surface that is closest to the plane formed by the flange in a direction transverse to the plane formed by the flange. It will be apparent that if the housing contains several clamps, not every clamp screw must be accessible through the same recess. Preferably there is a recess in the socket for each clamp screw. Because the clamp screw of the at least one clamp can be reached with a screwdriver through a recess in the socket, the socket does not have to be removed to install the socket in a wall or in a piece of furniture.

This flush-mounted module is advantageous because a socket can be built into a wall, floor socket or piece of furniture in fewer steps. The flush-mounted module only needs to be connected and installed. A flush-mounted box is unnecessary.

An additional advantage of the flush-mounted module is that it can be built into the wall, floor socket or piece of furniture from the same side of the wall, floor socket or piece of furniture as from where the functional part of the socket is accessible after incorporation of the flush-mounted module. It is not necessary to be able to reach a back of the wall or an inside of the furniture. This is particularly advantageous if the flush-mounted module needs to be replaced in the event of a defect, as the back of the wall or the inside of the furniture is not always accessible. It is also advantageous that the flange and the at least one clamp ensure that the functional part of the socket is automatically located at the correct distance from the mentioned side of the wall, floor socket or piece of furniture after incorporation of the flush-mounted module. It is not necessary to adjust the depth of the functional part of the socket in relation to the mentioned side of the wall, floor socket or piece of furniture or to provide different flush-mounted modules depending on the thickness of the wall, floor socket or piece of furniture.

According to a preferred embodiment, after perpendicular projection onto the plane formed by the front wall, a center point of the clamp screw of the at least one clamp lies within a polygon. The polygon has a number of sides. The polygon is for instance a triangle, a rectangle, a pentagon, a hexagon, . . . . The polygon has preferably at least three sides, more preferably at least four sides. In a most extreme embodiment, the polygon has an infinite number of sides, resulting in a circle. Preferably the clamp screw of the at least one clamp lies within the polygon. The polygon is a smallest possible polygon with said number of sides around an enveloping outline of a smallest possible insulation surface around the contact points of the socket. This means that when the polygon is a triangle, the polygon is the smallest possible triangle around said enveloping outline. An enveloping outline is a smallest possible circle in the plane formed by the front wall around the smallest possible insulation surface. Preferably the clamp screw of the at least one clamp lies behind the front wall. It is clear that when the flange extends in a direction parallel to the front wall, a perpendicular projection onto the plane formed by the front wall or a perpendicular projection onto the plane formed by the flange is identical.

This flush-mounted module is advantageous because a polygon offers more freedom of form for the flush-mounted module. Because the center point of the clamp screw of the at least one clamp lies within the polygon, the flush-mounted module has much more limited dimensions compared to a combination of a flush-mounted box with a socket according to the prior art.

According to a preferred embodiment the flush-mounted module comprises at least two sockets. After installation of the flush-mounted module, the at least two sockets are preferably aligned horizontally or vertically. Particularly advantageous embodiments comprise two, three or four sockets, which are horizontally aligned or two or three sockets that are vertically aligned after installation. The housing of the flush-mounted module comprises at least one clamp for clamping the flush-mounted module in a wall or in a piece of furniture and a clamp screw through each of the at least one clamp. The at least one clamp is preferably as previously described.

After perpendicular projection onto the plane formed by the flange, a center point of the clamp screw of the at least one clamp lies within a rectangle. Preferably the clamp screw of the at least one clamp lies within the rectangle. The rectangle is a smallest possible rectangle around each enveloping outline of a smallest possible insulation surface around the contact points of each individual socket. This means that when the flush-mounted module has two sockets, the rectangle is around the enveloping outline of both sockets. An enveloping outline is as previously described a smallest possible circle in the plane formed by the flange around the smallest possible insulation surface. Preferably the clamp screw of the at least one clamp lies behind the front wall.

This flush-mounted module is advantageous because at least two sockets can be built into a wall, floor socket or piece of furniture in fewer steps, using a single flush-mounted module. In case multiple sockets are combined in a single flush-mounted module, the flush mounted module must have at least a length and a width that corresponds to a long side and a short side of the rectangle. Because the center point of the clamp screw of the at least one clamp lies within the rectangle, the flush-mounted module has much more limited dimensions compared to a combination of a flush-mounted box with at least two sockets according to the prior art.

According to a further embodiment, centers of the enveloping outlines of the at least two sockets are on a line. A distance between two adjacent enveloping outlines, measured along said line, is preferably at most 20 mm, more preferably at most 15 mm, and even more preferably at most 10 mm. The distance is not the distance between the centers of the enveloping outlines, but the distance between closest points where the adjacent enveloping outlines cross said line. This embodiment is advantageous because it reduces further the dimensions of the flush-mounted module in a longitudinal direction, while not hindering use of the at least two sockets.

According to a preferred embodiment, the center point of the clamp screw of the at least one clamp lies within an oval area. Preferably the clamp screw of the at least one clamp lies within the oval area. The oval area is bounded by a semicircle part of the enveloping outline of a first socket, a semicircle part of the enveloping outline of a second socket and two parallel lines connecting the semicircles. The two parallel lines are connecting end points of the semicircle part of the first socket with end points of the semicircle part of the second socket. The enveloping outlines of the first socket and the second socket lie within the oval area. When the flush-mounted module comprises more than two sockets, the enveloping outlines of all socket lie preferably within the oval area. The oval area lies within the rectangle. Preferably the clamp screw of the at least one clamp lies behind the front wall.

This embodiment is advantageous because it is possible to obtain a flush-mounted module with dimensions that are reduced beyond the dimensions of the rectangle, while still guaranteeing the minimum required isolation surface around the contact points of the sockets. An oval area bounded by semicircle parts of the enveloping outlines and two parallel lines is beneficial for making the hole for installing the flush-mounted module. The hole can be made by drilling two holes and by sawing out the piece between the two holes.

According to a preferred embodiment, the flush-mounted module comprises one or more sockets. The flush-mounted module comprises at least one additional electrical base element. The additional electrical base element is different from a socket. Non-limiting examples of electrical base elements are sockets, switchgear such as switches, push-buttons, sensors, orientation lighting, data connections such as ethernet and USB, multimedia connections, etc. A functional part of the electrical base element is accessible through the front wall. Preferably the at least one additional electrical base element is a USB-connection for charging devices.

After perpendicular projection onto the plane formed by the front wall the additional electrical base element lies within a circle. The circle has a diameter that is equal to a diameter of the enveloping outlines of the smallest possible insulation surface around the contact points of the one or more sockets. The rectangle is a smallest possible rectangle around each enveloping outline of each individual socket of the one or more sockets and around said circle wherein the additional electrical base element lies. It is clear that when the flange extends in a direction parallel to the front wall, a perpendicular projection onto the plane formed by the front wall or a perpendicular projection onto the plane formed by the flange is identical.

This embodiment is advantageous for installing in a same spot besides a socket also other electrical base elements, while maintaining reduced dimensions for the flush-mounted module.

This embodiment can be advantageously combined with other embodiments comprising at least two sockets. The additional electrical base element may in these embodiments even replace one of the at least two sockets. This means that in embodiments with only two sockets, also embodiments with one socket and one additional electrical base element are envisaged.

According to a preferred embodiment, the center point of the clamp screw of the at least one clamp lies within the enveloping outline of a socket. The clamp screw of the at least one clamp can be reached with a screwdriver through a recess in the corresponding socket. When having a flush-mounted module comprising at least two clamps, then preferably at least the center point of a first clamp screw lies in the enveloping outline of a first socket and at least the center point of a second clamp screw lies in the enveloping outline of a second socket.

Because the clamp screw of the at least one clamp lies within an enveloping outline, no cover frame is required. This means that even less surface area is required for installing at least two sockets, which means there are more installation options than with a combination of a flush-mounted box with prior art sockets. It is particularly advantageous that the clamp screw of the at least one clamp can be reached with a screwdriver through a recess in the socket, so that the sockets do not have to be removed in order to install the sockets in a wall or in a piece of furniture.

According to a preferred embodiment, a clamp is placed at each short side of the rectangle. This means that the flush-mounted module comprises at least two clamps. This is advantageous for a good clamping of the flush-mounted module and to avoid rotations of the flush-mounted module around a longitudinal axis when plugging in or out a plug.

According to a preferred embodiment, a clamp is placed at each long side of the rectangle. This means that the flush-mounted module comprises at least two clamps. This is advantageous for a good clamping of the flush-mounted module and to avoid rotations of the flush-mounted module around an axis according to a width direction when plugging in or out a plug. Preferably the clamp is placed in the middle of the long side.

It is clear that this embodiment can be beneficially combined with a previously described embodiment wherein a clamp is placed at each short side of the rectangle.

According to a preferred embodiment the at least two sockets are electrically interconnected. The at least two sockets are electrically interconnected by electrical wires, metal strips or another suitable electrical conductor. This embodiment is advantageous because the flush-mounted module only needs to be connected once to cabling in the wall or in the piece or furniture in order to connect all of the at least two sockets to an electrical installation.

According to a preferred embodiment, the front wall comprises an opening for the clamp screw of the at least one clamp. The clamp screw of the at least one clamp can be reached with a screwdriver through the opening in the front wall. If the housing contains multiple clamps, there is a separate opening in the front wall for each clamp screw. Between an edge of the opening and the screw head of the clamp screw there is a gap of preferably at most 1.5 mm, more preferably at most 1.0 mm and even more preferably at most 0.5 mm. This is advantageous to ensure that the front wall sufficiently shields live parts of the socket. This embodiment is advantageous because the flush-mounted module can be clamped immediately. The front wall of the flush-mounted module does not have to be removed from the housing to tighten the clamp screw of the at least one clamp. This embodiment is particularly advantageous in a housing in which the front wall and the one or more side walls are one piece. Optionally, a cover cap is placed in the opening for the clamp screw of the at least one clamp. The cover cap is preferably made of plastic or synthetic rubber.

According to an alternative embodiment, the front wall is removable. The front wall is screwed, clicked, clamped or removably attached in another suitable manner in the housing or on the socket. Preferably, the front wall is removably clicked or clamped in the housing or on the socket. As a result, the front wall can be installed without the use of tools. The front wall is preferably removable without the use of tools. If the front wall is clicked or clamped in the housing or on the socket, it is not suggested to a person after incorporation of the flush-mounted module that parts of the flush-mounted module are removable. If the front wall is screwed into the housing, the front wall comprises at least one opening for a mounting screw for screwing down the front wall. Optionally, a cover cap is placed in the at least one opening for the mounting screw. The cover cap is preferably made of plastic or synthetic rubber.

An alternative is where the front wall is removably attached to the housing or to the socket using a bayonet connector. An advantage here is that the front wall can be removed using a plug. By not pressing the plug completely into the socket, but only into the front wall, the front wall can be removed or attached by rotating the plug.

The front wall covers the clamp screw of the at least one clamp. The front wall advantageously conceals the clamp screw of the at least one clamp, so that the clamp screw of the at least one clamp is not directly accessible after incorporation of the flush-mounted module and the flush-mounted module cannot easily be removed from a wall or from a piece of furniture. Because the front wall is removable, it is still possible to remove the flush-mounted module from the wall, floor socket or piece of furniture in the event of replacement. It will be apparent that the front wall can be placed in front of the socket even before installing the flush-mounted module. The disadvantage here is that in that case the front wall must first be removed before installation.

According to a further embodiment, the front wall is positioned recessed in the hollow body. Between an outline of the front wall and the one or more side walls of the hollow body there is a gap of at most 1.5 mm, preferably at most 1.0 mm and more preferably at most 0.5 mm. The gap is measured in the plane formed by the front wall and transverse to the outline of the front wall. The flange forms a visible surface of the flush-mounted module. This means that the flange remains visible after incorporation of the flush-mounted module and is not covered by a cover frame. The gap of at most 1.5 mm is advantageous to ensure that the front wall sufficiently shields live parts of the socket. The front wall also appears to form a whole with the one or more side walls of the housing of the flush-mounted module due to the narrow gap, making a cover frame unnecessary to cover a space between the front wall and the one or more side walls of the housing. This embodiment is particularly advantageous for sockets that, for example due to legal regulations, require the functional part of the socket to be recessed. Examples of this are sockets of types E and F according to standard IEC 60083:2015.

According to an alternative embodiment, the front wall is positioned on the flange. The front wall is removable as previously described. The front wall hides the flange. As a result, the flange does not have to be finished accurately, as it is not a visible surface. Only the front wall needs to be manufactured more precisely. The front wall preferably has a thickness of at most 2.0 mm, more preferably at most 1.5 mm and even more preferably at most 1.0 mm. Preferably, the front wall comprises a recess at a rear for receiving the flange. This means that the front wall can still be placed just as close to a wall, floor socket or piece of furniture. Because the front wall is positioned on the flange, it is not possible to touch live parts of the socket. A cover frame is unnecessary. The front wall is preferably flat on an outside of the flush-mounted module. This is particularly advantageous for sockets that do not require the functional part of the socket to be recessed, such as a socket of types B and G according to the IEC 60083:2015 standard. Alternatively, the front wall comprises a circular recess, wherein the recess forms a functional part of the socket. This is particularly advantageous for sockets that require the functional part of the socket to be recessed, such as sockets of types E and F according to the IEC 60083:2015 standard.

It is clear that in case the flush-mounted module comprises at least two sockets, the front wall comprises a recess for each socket of type E or F according to standard IEC 60083:2015.

If the front wall includes a recess for receiving the flange, the front wall preferably extends at least 0.5 mm beyond the flange, more preferably at least 1.0 mm.

According to an embodiment, the front wall comprises a raised edge. The raised edge forms an enveloping outline of the smallest possible insulation surface. This embodiment is advantageous for sockets that, for example due to legal regulations, require that the functional part of the socket is recessed, such as sockets of types E and F according to the IEC 60083:2015 standard, but where only a small installation depth is available for the flush-mounted module, which makes it not possible to position the front wall recessed in the hollow body, as in a previously described embodiment.

It is clear that in case the flush-mounted module comprises at least two sockets, the front wall comprises a raised edge for each socket of type E or F according to standard IEC 60083:2015.

According to a preferred embodiment, the flush-mounted module comprises an electrical cable for connecting the flush-mounted module. The electrical cable extends through the back wall of the housing of the flush-mounted module. The cable is connected to the socket at a first end in the housing. The cable comprises a connector at a second end for connecting the cable to an electrical installation in a building. Preferably, the connector is a plug according to the IEC 60083:2015 standard. Alternatively, the cable includes contacts at the second end for connecting the cable to the electrical installation. This embodiment is advantageous in that the socket does not have to be removed from the housing to connect the socket to the electrical installation, so that the socket can be built in more quickly.

Preferably the electrical cable extends through a slot in the back wall. Preferably the slot continues partly in a side wall of the housing. This is advantageous for mounting the flush-mounted module through a hole in a wall, floor socket or piece of furniture. The cable can extend through the back wall of the housing while placing the flush-mounted module through the hole in the wall or in the piece of furniture and can extend after placing the flush-mounted module in said hole through the side wall of the housing, requiring less installation depth for the flush-mounted module in the wall, floor socket or in the piece of furniture.

It is clear that in case this embodiment is combined with a previously described embodiment, wherein the flush-mounted module comprises at least two sockets that are electrically interconnected, the flush-mounted module only requires one electrical cable.

It is also clear that in case the flush-mounted module comprises at least two sockets, but the at least two sockets are not electrically interconnected or the at least two sockets are divided in multiple groups of electrically interconnected sockets, which groups are not electrically interconnected between them, a cable is provided for each of the at least two sockets or for each group of electrically interconnected sockets. This is advantageous in case that for instance a socket or a group of electrically interconnected sockets can be switched on and off.

An additional advantage of a cable with a connector at the second end is that when connecting the cable to the electrical installation, the connection does not have to be made in a junction box. This means that no additional space needs to be provided in the wall or in the piece of furniture for a junction box and the installation of the flush-mounted module can be faster. It is also not necessary to make an opening in the wall, floor socket or piece of furniture that is larger than required for installation of the flush-mounted module, in order to place a junction box through that opening in the wall, floor socket or piece of furniture. Nor is it necessary that a back of the wall or an inside of the piece of furniture is accessible for installing a junction box. However, a cable with contacts at the second end is preferably connected to the electrical installation in a junction box.

According to an alternative embodiment, the flush-mounted module comprises connectors in the back wall for connecting an electrical cable. The electrical cable is, for example, a cable of an electrical installation in a building. The connectors are connected inside the housing to the socket's contact points. This embodiment has the same advantage as the previous embodiment.

The connectors are preferably located inside the housing. This is advantageous to shield the connectors and to avoid electrocution or short circuits. A back wall comprising connectors means that the electrical cable can be connected to the flush-mounted module without opening the housing. The back wall comprises an opening for attaching the electrical cable to the connectors. Preferably the back wall comprises a separate opening for each wire of the electrical cable. The connectors may comprise a spring-loaded clamp for clamping the wires of the electrical cable. The connectors may comprise a screw for fastening the wires of the electrical cable. The screws are reachable through the back wall. Alternatively the screws are reachable through the side wall.

It is clear that in case this embodiment is combined with a previously described embodiment, wherein the flush-mounted module comprises at least two sockets that are electrically interconnected, the flush-mounted module only requires one set of connectors for connecting one electrical cable.

It is also clear that in case the flush-mounted module comprises at least two sockets, but the at least two sockets are not electrically interconnected or the at least two sockets are divided in multiple groups of electrically interconnected sockets, which groups are not electrically interconnected between them, a set of connectors is provided for each of the at least two sockets or for each group of electrically interconnected sockets. This has the same advantage as previously described.

According to a preferred embodiment, a cover is attached to the housing on the back wall. The cover is preferably removable. In case the back wall comprises connectors for connecting an electrical cable, as in a previously described embodiment, the cover is removable. The cover is screwed, clicked or secured in another suitable way to the back wall. The cover guides an electrical cable connecting the socket to an electrical installation in a building for strain relief at an angle of at least 30° with respect to a perpendicular on the back wall, preferably at least 35° and more preferably at least 40°. The strain relief is advantageous to prevent the electrical cable from coming loose or partially coming loose when installing the flush-mounted module, which could potentially cause a fire hazard.

Preferably the angle with respect to the perpendicular is at most 80°, more preferably at most 70°, even more preferably at most 60° and even more preferably at most 50°. This is advantageous because at larger angles the electrical cable may be damaged internally, causing poor contacts, which may pose a fire hazard.

This embodiment is particularly advantageous if the back wall contains connectors for connecting an electrical cable, because the connection of the flush-mounted module to the electrical installation does not have to be done in a separate junction box. The cover on the back wall forms, as it were, a junction box. Similar advantages are achieved as previously described for an embodiment in which the flush-mounted module comprises a cable with a connector at the second end.

According to a preferred embodiment, the socket is attached to the back wall of the housing. This embodiment is advantageous both if the front wall and/or the back wall is removable. In both cases, no facilities are required on one or more side walls for securing the socket in the housing. This allows the housing to fit closer to the socket, viewed in a plane parallel to the plane formed by the flange, resulting in a flush-mounted module with a smaller cross-section. This allows the flush-mounted module to be built into a hole with a smaller diameter in a wall or in a piece of furniture. This embodiment is particularly advantageous if the socket is placed in the housing via a removable front wall. The socket can remain attached in the housing, regardless of possible actions with the front wall.

It will be apparent that a similar advantage can be obtained by mounting the socket on the front wall. This embodiment is particularly advantageous if the socket is placed in the housing via a removable back wall. The socket can remain attached in the housing, regardless of possible actions with the back wall.

According to a preferred embodiment, the front wall is circular with a diameter of 39 mm±1 mm or there is a circular recess in the front wall with an inner diameter of 39 mm±1 mm. The front wall is preferably circular and recessed into the housing. The clamp screw of the at least one clamp is placed on a circular outline with a diameter of at most 36 mm, preferably on a circular outline with a diameter of at most 35 mm, more preferably on a circular outline with a diameter of at most 34 mm, even more preferably on a circular outline with a diameter of not more than 33 mm and even more preferably on a circular outline with a diameter of not more than 32 mm. The circular outline and the front wall are concentric.

This embodiment is particularly advantageous for a socket of type E or F according to the IEC 60083:2015 standard. The smallest possible insulation surface for a socket of type E or F is a circle with a diameter of 39±1 mm. A circular front wall with the mentioned diameter or a front wall with a circular recess with the mentioned inner diameter is advantageous for obtaining a housing with minimum dimensions for a socket of type E or F. The circular outline of a maximum of 36 mm is advantageous because it means that a clamp screw with a screw head with a diameter of 6 mm falls completely within the circular front wall or the circular recess.

According to a further embodiment, the cylindrical space in which the hollow body can be placed has an inner diameter of 42 mm±3 mm, preferably an inner diameter of 42 mm±2.5 mm. This leaves sufficient space around the front wall or the recess in the front wall for a cylindrical housing with a wall thickness of at least 0.8 mm, while the bore diameter for a hole in which the flush-mounted module is installed remains very limited.

Preferably the cylindrical space has an inner diameter of at most 44 mm, more preferably at most 43.5 mm, even more preferably at most 43 mm and even more preferably at most 42.5 mm.

Preferably, the cylindrical space has an inner diameter of at least 40 mm, more preferably at least 40.5 mm, even more preferably at least 41 mm and even more preferably at least 41.5 mm.

According to a preferred embodiment, the cylindrical space in which the hollow body can be placed has an inner diameter of 44 mm±4 mm. The clamp screw of the at least one clamp is placed on a circular outline with a diameter of at most 36 mm, preferably on a circular outline with a diameter of at most 35 mm, more preferably on a circular outline with a diameter of at most 34 mm, even more preferably on a circular outline with a diameter of not more than 33 mm and even more preferably on a circular outline with a diameter of not more than 32 mm. The circular outline and the front wall are concentric.

This embodiment is particularly advantageous for a type G socket according to the IEC 60083:2015 standard. A type G socket requires at least 3 mm of insulation material around the openings for the socket contact points. The enveloping circle for the smallest possible insulation surface for the type G socket fits within a cylindrical space with an internal diameter of 44 mm±4 mm. There is sufficient space for a cylindrical housing with a wall thickness of at least 0.8 mm, while the bore diameter for a hole in which the flush-mounted module is installed remains very limited. The circular outline of a maximum of 36 mm is advantageous because it allows a clamp screw with a screw head with a diameter of 6 mm to fit completely within the housing.

The enveloping circle of a type G socket is a circumscribed circle of a triangle. A circumscribed circle is a circle that passes through all vertices of the triangle. A type G socket has a rectangular opening to a grounding contact point, usually marked with the letter E (“Earth”), a rectangular opening to a phase connection contact point, usually marked with the letter L (“Line”), and a rectangular opening to a contact point for a neutral connection, usually indicated by the letter N (“Neutral”). Each rectangular opening has a long and a short axis of symmetry. A first vertex of the triangle is located on the long axis of symmetry from the rectangular opening to the ground contact point, at a distance of 3 mm from said rectangular opening, measured along the long axis of symmetry, and away from the two remaining rectangular openings. A second vertex of the triangle is located along both the long axis of symmetry and the short axis of symmetry from the rectangular opening to the contact point for the phase connection, at a distance of 3 mm from the said rectangular opening, and away from the two other rectangular openings. A third vertex of the triangle is located along both the long axis of symmetry and the short axis of symmetry from the rectangular opening to the contact point for the neutral connection, at a distance of 3 mm from the said rectangular opening, and away from the two other rectangular openings. A center of the circumscribed circle of the triangle is determined by an intersection of perpendicular bisectors on at least two sides of the triangle. A radius of the circumscribed circle is equal to a distance from the center to a vertex of the triangle.

Preferably, the cylindrical space has an inner diameter of at most 47 mm, more preferably at most 46 mm, even more preferably at most 45 mm and even more preferably at most 44.5 mm.

Preferably, the cylindrical space has an inner diameter of at least 41 mm, more preferably at least 42 mm, even more preferably at least 43 mm and even more preferably at least 43.5 mm.

According to a preferred embodiment, the cylindrical space in which the hollow body can be placed has an inner diameter of 36.5 mm±3 mm. The clamp screw of the at least one clamp is placed on a circular outline with a diameter of at most 28.5 mm, preferably on a circular outline with a diameter of at most 28 mm, more preferably on a circular outline with a diameter of at most 27.5 mm, even more preferably on a circular outline with a diameter of not more than 27 mm and even more preferably on a circular outline with a diameter of not more than 26.5 mm. The circular outline and the front wall are concentric.

This embodiment is particularly advantageous for a type B socket according to the IEC 60083:2015 standard. The enveloping circle for the smallest possible insulation surface for the type B socket fits within a cylindrical space with an internal diameter of 36.5 mm±3 mm. There is sufficient space for a cylindrical housing with a wall thickness of at least 0.8 mm, while the bore diameter for a hole in which the flush-mounted module is installed remains very limited.

Preferably, the cylindrical space has an inner diameter of at most 39 mm, more preferably at most 38 mm, even more preferably at most 37.5 mm and even more preferably at most 37 mm.

Preferably, the cylindrical space has an inner diameter of at least 34 mm, more preferably at least 35 mm, even more preferably at least 35.5 mm and even more preferably at least 36 mm.

According to a preferred embodiment, the flange is circular. The flange and the cylindrical space are concentric. The flange has a radius that is at least 1 mm and at most 5 mm larger than a radius of the cylindrical space.

The radius of the flange is preferably at most 4.5 mm larger than the radius of the cylindrical space, more preferably at most 4.0 mm, even more preferably at most 3.5 mm and even more preferably at most 3.0 mm.

A radius that is at least 1 mm larger is a minimal radius to prevent the flush-mounted module from being pressed through the hole in the wall, floor socket or piece of furniture. A radius that is at most 5 mm larger is advantageous for achieving a minimum dimension of the flush-mounted module, which means that a very small surface area is required to install a socket in a wall, floor socket or piece of furniture.

This embodiment is particularly advantageous in combination with a hollow body that is substantially cylindrical or substantially a truncated conical shape. Because the flange has a radius that is at most 5 mm larger than the radius of the cylindrical space, the hollow body fits closely against the cylindrical space. This allows the hollow body to hardly deform when screwing the clamp screw through the at least one clamp. Nor can the hollow body deform much by, for example, pressing a plug into the socket. This allows one or more side walls to be made thinner, so that the flush-mounted module takes up less space.

According to an embodiment, the hollow body is substantially cylindrical or substantially a truncated conical shape. The clamp can be moved along the hollow body to the plane formed by the flange. The at least one clamp is movable from a folded in position to a folded out position. The at least one clamp includes a curved surface. In the folded in position, the curved surface joins the hollow body. The at least one clamp comprises a hinged arm at a first end of the curved surface. The hinged arm extends transversely to the curved surface and parallel to the plane formed by the flange. The clamp screw is located at a free end of the hinged arm. A second end of the curved surface, opposite the first end, extends towards the plane formed by the flange for a distance of at least 5 mm, the distance being measured transversely to the plane formed by the flange. This is advantageous for increasing the adjustment range of the at least one clamp, allowing the flush-mounted module to be clamped behind thin walls.

This embodiment is particularly advantageous in the event that the socket, due to its dimensions, prevents the clamp screw of the at least one clamp from being placed near the side wall of the hollow body when the flush-mounted module fits closely to the socket, for example because the socket extends deep into the hollow body along one or more side walls. However, it is possible that the socket extends less deeply into the hollow body at positions further away from the one or more side walls of the hollow body and the clamp screw of the at least one clamp can be positioned there under, along or through the socket. By using the hinged arm, the operation of the at least one clamp remains unchanged and when the clamp screw of the at least one clamp is tightened, the at least one clamp will move from the folded in position to the folded out position and then along the one or more side walls of the hollow body to the flange. As a result, a flush-mounted module with minimal dimensions remains possible. An additional advantage is that the curved surface makes this flush-mounted module not only suitable for clamping behind a wall or behind the inside of a piece of furniture, but for example in a cylindrical space that has been drilled into a brick or concrete wall or a thick wall. The curved surface will clamp against a side wall of the cylindrical space.

According to an embodiment, the clamp screw of the at least one clamp is placed at a distance of no more than 5 mm behind the front wall. This embodiment is particularly advantageous when using a clamp that can be moved along the hollow body to the plane formed by the flange. This is advantageous because it means that at least one clamp has a very large adjustment range. The at least one clamp can be moved very close to the flange, making the flush-mounted module suitable for clamping behind thin walls.

According to an embodiment, the at least one clamp is movable from a folded in position to a folded out position. In the folded in position, the at least one clamp, after perpendicular projection onto the plane formed by the flange, lies within the enveloping outline of the smallest possible insulation surface around the contact points of the socket. This is advantageous because it means that the at least one clamp does not protrude beyond an outline of the flush-mounted module, which would hinder the placement of the flush-mounted module.

According to an embodiment, the flush-mounted module comprises two clamps. The flush-mounted module preferably comprises two clamps. The two clamps can be moved along the hollow body to the plane formed by the flange by tightening their clamp screw. The two clamps can be moved from a folded in position to a folded out position. The centerlines of the clamp screws of the two clamps lie on a circle. The said circle is concentric with the flange. Viewed in a plane parallel to the plane formed by the flange, a first of the two clamps extends from the clamp screw of the first clamp for a greater distance than a second of the two clamps extends from the clamp screw of the second clamp. The first clamp preferably extends arcuately from the clamp screw of the first clamp. A central angle of a circular arc on the said circle with the centerlines of the clamp screws of the first clamp and the second clamp as endpoints is at least 110° and at most 160°. The central angle is the angle determined by the center of the said circle as a vertex, a line through the centerline of the clamp screw of the first clamp and a line through the centerline of the clamp screw of the second clamp.

Preferably, the central angle is at least 115°, more preferably at least 120°, even more preferably at least 125° and even more preferably at least 130°.

Preferably, the central angle is at most 155°, more preferably at most 155°, even more preferably at most 145° and even more preferably at most 140°.

This embodiment is advantageous because due to the greater length of the first clamp compared to the second clamp, the first clamp in the folded out position extends further from the hollow body than the second clamp. In the folded out position, the first clamp reaches at least to a diameter of the mentioned circle through the centerline of the clamp screw of the second clamp. As a result, the first clamp and the second clamp, after perpendicular projection onto the plane formed by the flange, can be clamped diametrically with respect to a central point of a cross-section of the hollow body in the said plane, against a rear side of the thin wall or against an inside of the piece of furniture, thereby achieving a very good clamping of the flush-mounted module.

This embodiment is particularly advantageous in combination with a socket of type B according to standard IEC 60083:2015. Because the first clamp is longer than the second clamp, the clamp screws do not have to be diametrically opposite each other on the aforementioned circle and it is also possible to move the clamp screws further inside the flush-mounted module. The clamp screw of the first clamp is located between the first contact point and a grounding point of the socket. The clamp screw of the second clamp lies on the said circle between a first and a second contact point of the socket. With a type B socket it is not possible to place the clamp screws diametrically opposite each other on the mentioned circle.

According to an embodiment, the flush-mounted module comprises three clamps. Preferably, the flush-mounted module contains three clamps. In a plane parallel to the plane formed by the flange, there is an angle of at least 110° and at most 160° between a first clamp screw and a second clamp screw. There is an angle of at least 110° and at most 160° between the first clamp screw and a third clamp screw.

Preferably, the angle between the first clamp screw and the second clamp screw is equal to the angle between the first clamp screw and the third clamp screw. A vertex of the angles mentioned coincides with a center of the circle on which the clamp screws are placed. It will be apparent that the first clamp screw is the clamp screw of a first clamp, the second clamp screw is the clamp screw of a second clamp and the third clamp screw is the clamp screw of a third clamp.

Preferably, the angle between the first clamp screw and the second clamp screw is at least 115°, more preferably at least 120°, even more preferably at least 125° and even more preferably at least 130°.

Preferably, the angle between the first clamp screw and the second clamp screw is at most 155°, more preferably at most 150°, even more preferably at most 145° and even more preferably at most 140°.

Preferably, the angle between the first clamp screw and the third clamp screw is at least 115°, more preferably at least 120°, even more preferably at least 125° and even more preferably at least 130°.

Preferably, the angle between the first clamp screw and the third clamp screw is at most 155°, more preferably at most 150°, even more preferably at most 145° and even more preferably at most 140°.

This embodiment is particularly advantageous for type B sockets according to standard IEC 60083:2015. Because the three clamp screws are not evenly distributed over the circular outline, it is possible to move the clamp screws further inside the flush-mounted module. The first clamp screw lies on the circular outline between a first and a second contact point of the socket. The second clamp screw is located between the first contact point and a grounding point of the socket. The third clamp screw is located between the second contact point and the grounding contact.

According to an embodiment, the flush-mounted module comprises a removable ring. The ring includes a recess on an inner outline. The recess is suitable for receiving the flange of the flush-mounted module. The recess has an inner edge with a diameter equal to an inner diameter of the ring. The recess has an outer edge with a diameter that is preferably at most 1.5 mm larger than the diameter of the front wall, more preferably at most 1.0 mm and even more preferably at most 0.5 mm. As a result, the front wall fits closely to the removable ring. After placing the flush-mounted module in a wall, floor socket or piece of furniture, the removable ring is clamped between the flange of the flush-mounted module and the wall, floor socket or piece of furniture.

This embodiment is advantageous because after placement, the removable ring covers the wall, floor socket or piece of furniture at an edge of an opening in the wall, floor socket or piece of furniture in which the flush-mounted module is placed. This results in a neat finish. If, when making the opening, the wall, floor socket or piece of furniture is damaged at the edge of the opening, such as splinters in the case of wooden board material or small chips in the case of stone board material, the removable ring will cover this minor damage. Thus, there is no need to repair or touch up the edge of the opening.

This embodiment is also advantageous in combination with an embodiment of the method described below, in which a mounting plate is placed on the wall, floor socket or piece of furniture. This mounting plate is plastered or covered in another way. When plastering or covering the mounting plate, it is possible that the plaster or covering around the opening for the flush-mounted module in the hollow wall is not completely flat or does not completely fit the opening. The removable ring covers the plaster or covering around the opening, creating a neat finish.

In a second aspect, the invention concerns a method for flush mounting a socket in a wall, floor socket or in a piece of furniture.

The method comprising the steps of:
providing a flush-mounted module comprising a housing and a socket,
making an opening for the flush-mounted module in the wall or in the piece of furniture,
connecting the flush-mounted module to cabling in the wall or in the piece of furniture,
placing the flush-mounted module in the opening in the wall, floor socket or piece of furniture,
tightening the clamp screw of the at least one clamp to clamp the flush-mounted module in the opening.

The wall is, for example, a wooden or metal frame covered with plasterboard, a backsplash in a kitchen, a brick or concrete wall, etc.

The piece of furniture is, for example, a cupboard, a table, a seat, etc.

The housing comprises a hollow body with a front wall, back wall, one or more side walls, a flange, at least one clamp for clamping the flush-mounted module in the wall or in the piece of furniture and a clamp screw through each of the at least one clamps. The socket is mounted behind the front wall in the housing. The front wall comprises openings to contact points of the socket.

The opening may be circular, rectangular, squared or have another suitable shape. For instance a rectangular or square opening is well suited for housing a hollow body that is for example substantially beam-shaped, especially in combination with a square or rectangular flange. Preferably the opening is a round opening.

The opening is sawn or drilled in the wall or in the piece of furniture. A round opening creates a cylindrical space. It will be apparent that the cylindrical space is not necessarily a real space but can also be a virtual cylindrical space with a diameter equal to a diameter of the hole, which is available in a larger real space in a wall, floor socket or piece of furniture.

It is clear that when using previously described embodiments, wherein the flush-mounted module comprises at least two sockets, the opening does not have to be round and the space is not necessarily cylindrical.

When placing the flush-mounted module, the hollow body is positioned through the opening in the wall or in the piece of furniture. The flange leans against the wall, floor socket or piece of furniture.

When carrying out the method, a flush-mounted module according to the first aspect is used.

This method has the advantage that a socket can be built into a wall, floor socket or piece of furniture in fewer steps. The flush-mounted module only needs to be connected and installed. It is particularly advantageous that less surface area is required for installing the socket, which means there are more installation options for installing the socket in the wall or in the piece of furniture.

When using previously described embodiments, wherein the flush-mounted module comprises at least two sockets, this method has the advantage that at least two sockets can be built into a wall, floor socket or piece of furniture in fewer steps, using a single module.

According to a further embodiment, the front wall is removed before placing the flush-mounted module in the opening in the wall or in the piece of furniture. The method includes the additional step of placing the front wall after tightening the clamp screw of the at least one clamp. The front wall covers the clamp screw of the at least one clamp. This is advantageous because the clamp screw of the at least one clamp is not immediately accessible after incorporation of the flush-mounted module and the flush-mounted module cannot easily be removed from a wall or from a piece of furniture.

According to an embodiment, a recess is provided around the opening. The opening is preferably a round opening. The recess is preferably milled into the wall or into the piece of furniture. The recess is suitable for receiving the flange. This is advantageous for fully flush mounting of the socket in a wall, floor socket or piece of furniture. In combination with the minimum dimensions of the flush-mounted module, it appears as if the wall, floor socket or piece of furniture runs flush. The wall, floor socket or piece of furniture is only visually disturbed to a very minimal extent. Preferably, the recess fits around the flange. This is advantageous because the wall, floor socket or piece of furniture does not have to be further finished after placement of the flush-mounted module.

According to an embodiment, before placing the flush-mounted module in the opening in the wall, floor socket or piece of furniture, the flush-mounted module is placed through a removable ring.

The ring includes a recess on an inner outline. The flange of the flush-mounted module is accommodated in the recess. The recess has an inner edge with a diameter equal to an inner diameter of the ring. The recess has an outer edge with a diameter that is preferably at most 1.5 mm larger than the diameter of the front wall, more preferably at most 1.0 mm and even more preferably at most 0.5 mm. As a result, the front wall fits closely to the removable ring. The removable ring is clamped between the flange of the flush-mounted module and the wall, floor socket or piece of furniture.

This embodiment is advantageous because after placement of the flush-mounted module in the wall or the piece of furniture, the removable ring covers the wall, floor socket or piece of furniture at an edge of an opening in the wall, floor socket or piece of furniture in which the flush-mounted module is placed. This results in a neat finish. If, when making the opening, the wall, floor socket or piece of furniture is damaged at the edge of the opening, such as splinters in the case of wooden board material or small chips in the case of stone board material, the removable ring will cover this minor damage. Thus, there is no need to repair or touch up the edge of the opening.

According to an embodiment, the method comprises the additional step of placing a mounting plate on a front side of the wall, floor socket or piece of furniture. The mounting plate comprises a cylindrical wall that extends on the mounting plate. The cylindrical wall has an open base surface and an open top surface. The cylindrical wall bounds a cylindrical space. The mounting plate is interrupted at the open base surface. The mounting plate is glued, screwed or secured in another suitable manner to the front of the wall, floor socket or piece of furniture. The mounting plate is plastered or covered up to the open base surface of the cylindrical wall. The mounting plate is, for example, covered with fabric, leather, wallpaper or another suitable material. The cylindrical space extends through the round opening in the wall, floor socket or piece of furniture to the rear of the wall, floor socket or piece of furniture. The flush-mounted module is placed into the cylindrical space through the round opening in the wall, floor socket or piece of furniture. While tightening the at least one clamp, the at least one clamp clamps against the rear side of the wall, floor socket or piece of furniture or against the cylindrical wall.

Preferably, the mounting plate comprises a recess for receiving the flange of the flush-mounted module. This is advantageous because it allows the flange to be recessed not in the wall or the piece of furniture, but in the mounting plate. This is particularly advantageous with thin walls or pieces of furniture, where a recessed placement of the flange in the wall or in the piece of furniture can lead to breakage of the wall, floor socket or piece of furniture at the round opening.

This embodiment is particularly advantageous in combination with a previously described embodiment, in which the flush-mounted module is placed through a removable ring. When plastering or covering the mounting plate, it is possible that the plaster or covering around the opening for the flush-mounted module in the wall or the piece of furniture is not completely flat or does not completely fit the opening. The removable ring covers the plaster or covering around the opening, creating a neat finish.

One skilled in the art will appreciate that a flush-mounted module according to the first aspect is preferably configured for carrying out a method according to the second aspect and that a method according to the second aspect is preferably carried out with a flush-mounted module according to the first aspect. Each feature described in this document, both above and below, can therefore relate to any of the three aspects of the present invention.

In a third aspect, the invention concerns a use of a flush-mounted module according to the first aspect and/or a method according to the second aspect for flush mounting a socket in a wall or in a piece of furniture.

Preferably a flush-mounted module according to the first aspect and/or a method according to the second aspect is used for flush mounting at least two sockets in a wall or in a piece of furniture, using a single flush-mounted module.

This use results in an advantageous flush mounting of a socket with minimal visual impact. Because the center point of the clamp screw of the at least one clamp lies within an enveloping outline of the smallest possible insulation surface around the contact points of the socket, the flush-mounted module has minimal dimensions. Nor is a cover frame needed to hide the clamp screw of the at least one clamp. This means that less surface area is required to install the socket, which means there are more installation options. Due to a minimal thickness of the flange or of the part of the front wall that lies on the flange, it is possible to provide a recess in the wall or in the piece of furniture to this end, allowing the socket to be recessed into the wall, floor socket or piece of furniture. Due to the flush mounting of the socket in the wall, floor socket or piece of furniture in combination with the minimum dimensions of the flush-mounted module, it appears as if the wall, floor socket or piece of furniture runs flush. The wall, floor socket or piece of furniture is only visually disturbed to a very minimal extent.

In case a flush-mounted module comprising at least two sockets is used, the use is advantageous because the center point of the clamp screw of the at least one clamp lies within a smallest possible rectangle around each enveloping outline of the smallest possible insulation surface around the contact points of each individual socket, resulting in a flush-mounted module with minimal dimensions. The use has further similar advantages as described before.

In what follows, the invention is described by way of non-limiting figures illustrating the invention, and which are not intended to and should not be interpreted as limiting the scope of the invention.

### DESCRIPTION OF THE FIGURES

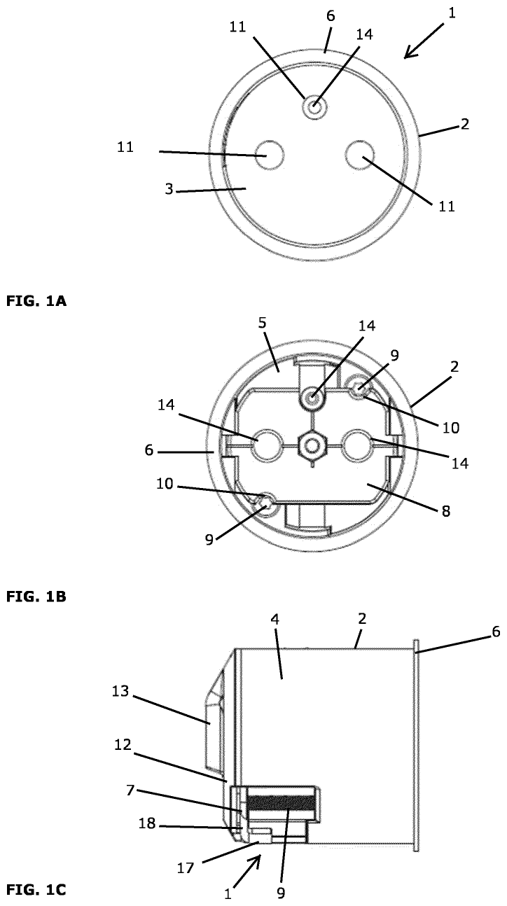

FIGS. 1A-1D show a front view, a front view without a front wall, a side view and a rear view, respectively, of a flush-mounted module according to an embodiment of the present invention with a socket type E according to the IEC 60083:2015 standard.

The flush-mounted module (1) comprises a housing (2) and a socket (8). The housing (2) comprises a hollow body with a front wall (3), a cylindrical side wall (4) and a back wall (5). The housing (2) comprises two clamps (7) for clamping the flush-mounted module (1). The housing (2) comprises a clamp screw (9) through each of the clamps (7). By tightening the clamp screws (9), the clamps (7) move along the hollow body to the flange (6). The flange (6) is located on a side of the front wall (3) of the housing (2). The flange (6) extends away from the hollow body in a direction parallel to the front wall (3). The housing (2) can be placed in a cylindrical volume up to the flange (6). The center points of the clamp screws (9) lie within an enveloping outline of the smallest possible insulation surface around the contact points (14) of the socket (8). In this embodiment, the smallest possible insulation surface is a circle with a diameter of 39 mm±1 mm. In this embodiment, the center points of the clamp screws (9) even lie on a circular outline with a diameter of only 30.9 mm. The clamp screws (9) can be reached with a screwdriver through recesses (10) in the socket (8). The clamp screws (9) are partially covered by the socket (8). This can be clearly seen in FIG. 1B. The front wall (3) is removable and clamped flush in the housing (2). The flange (6) is therefore a visible surface. The front wall (3) comprises three openings (11) for contact points (14), of which one opening (11) for an earth pin and two for live contact points (14). The socket (8) is mounted behind the front wall (3). The socket (8) is clicked into the housing. The front wall (3) covers the clamp screws (9). This can be clearly seen in FIG. 1A. A cover (12) is attached to the back wall (5). The cover (12) comprises a guide (13) that guides an electrical cable, not shown, parallel to the back wall (5) for strain relief.

FIG. 2 shows an exploded view of the flush-mounted module from FIGS. 1A-1D.

FIG. 2 clearly shows how the clamp screws (9) are positioned behind the socket (8). The recesses (10) are also clearly visible in FIG. 2. FIG. 2 also shows how the clamps (7) comprise a curved surface (17). In the folded in position, the curved surface (17) joins the hollow body, as shown in FIG. 1C. The clamps (7) comprise a hinged arm (18) at a first end of the curved surface (17). The hinged arm (18) extends transversely to the curved surface (17) and parallel to the plane formed by the flange (6). The clamp screws (9) are located at a free end of the hinged arm (18). A second end of the curved surface (17), opposite the first end, extends for a distance of at least 5 mm towards the plane formed by the flange (6).

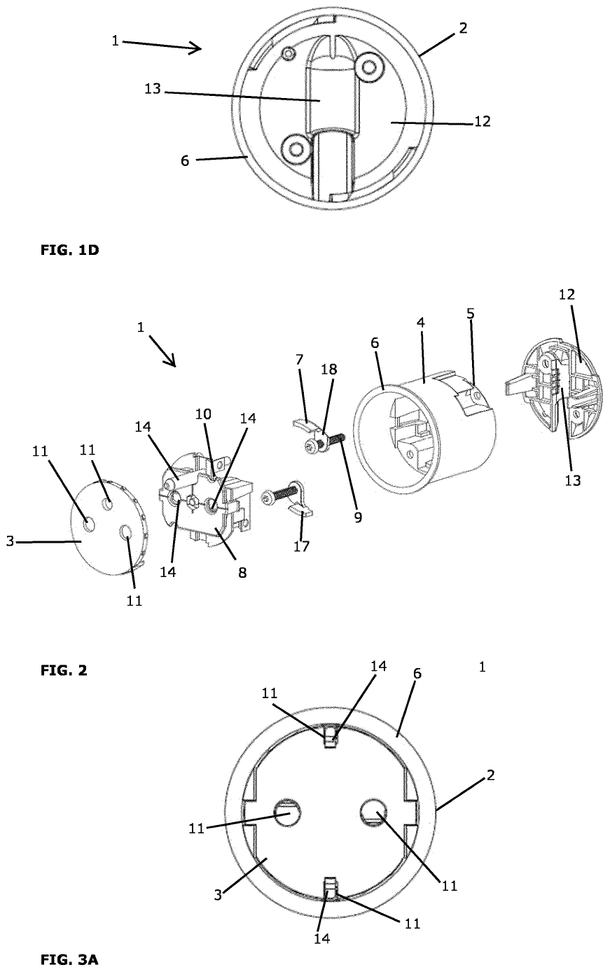

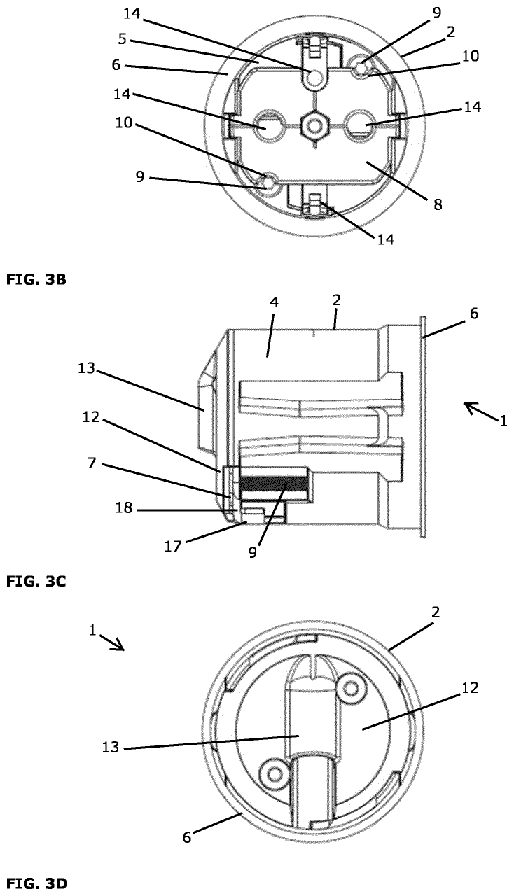

FIGS. 3A-3D show a front view, a front view without a front wall, a side view and a rear view of a flush-mounted module according to an embodiment of the current invention with a type F socket according to the IEC 60083:2015 standard.

This embodiment is very similar to the embodiment shown in FIGS. 1A-1D and FIG. 2. The description and specified dimensions for FIGS. 1A-1D and FIG. 2 apply almost identically. There are some minor differences in the shape of the housing (2). The main differences are the socket (8) and the front wall (3). The front wall (3) comprises two openings (11) for contact points (14) along an edge of the front wall (3). These contact points (14) are spring-loaded grounding contacts. The front wall (3) comprises two further openings (11) for contact points (14). These contact points (14) are live in operation and are equivalent to the live contact points (14) of a type E socket (8).

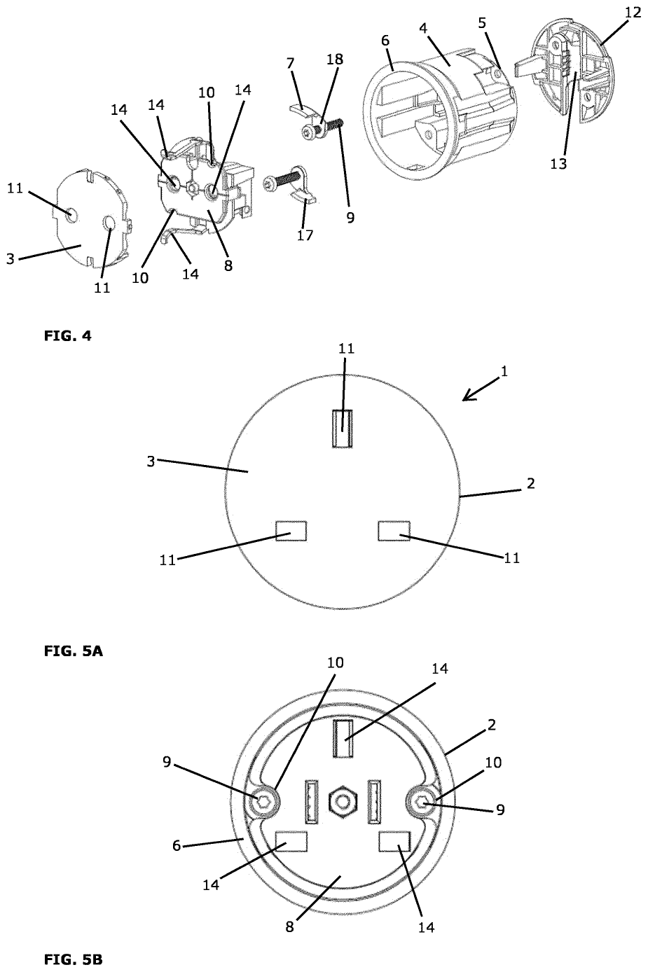

FIG. 4 shows an exploded view of the flush-mounted module from FIGS. 3A-3D.

Here too, the description of FIG. 2 applies almost identically. The differences between the sockets (8) and the front wall (3) are clearly visible between FIG. 2 and FIG. 4. Instead of a single earth pin, there is now a spring-loaded grounding contact at the top and bottom of the socket (8).

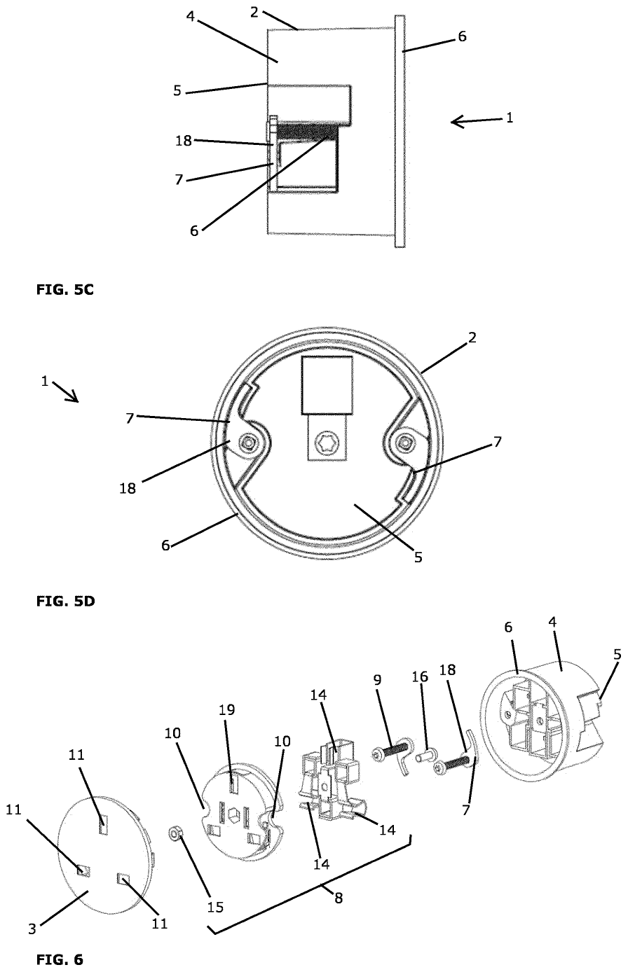

FIGS. 5A-5D show a front view, a front view without a front wall, a side view and a rear view of a flush-mounted module according to an embodiment of the current invention with a type G socket according to the IEC 60083:2015 standard.

The flush-mounted module (1) has a similar structure to the flush-mounted modules (1) from the previous figures, but elements of the flush-mounted module (1) are designed differently. The main difference is the socket (8) is of type G. Such a socket (8) does not require the front wall (3) to be recessed. The front wall (3) is removable and still covers the clamp screws (9). The front wall (3) is flat and positioned on the flange (6). The front wall (3) thus conceals the flange (6). In this embodiment the flange (6) is not a visible surface and does not have to be finished so accurately.

The socket (8) has recesses (10) so that the clamp screws (9) can again be reached with a screwdriver. The clamp screws (9) are now not partially covered by the socket (8). The clamp screws (9) are placed on a circular outline with a diameter of 34.2 mm. This is within an enveloping circle of the smallest possible insulation surface for a socket (8) of type G, where there must be at least 3 mm of insulation material around the contact points (14). The housing (2) is cylindrical with an inner diameter of 41.9 mm. The front wall (3) is also circular and has a diameter of 48.4 mm.

FIG. 6 shows an exploded view of the flush-mounted module from FIGS. 5A-5D.

FIG. 6 mainly shows how the socket (8) is constructed differently. The socket (8) comprises a plastic part with a mechanism that serves as a child safety device (19). A second part mainly comprises the contact points (14). These two parts are attached to each other with a screw (16) and a nut (15). As shown in FIG. 5C, the housing (2) has a very shallow depth. In this embodiment this is only 28.9 mm. Because the clamps (7) are closer to the flange (6), the clamps (7) are simpler and include only a hinged arm (18), but no curved surface (17) with a free end extending towards the flange (6).

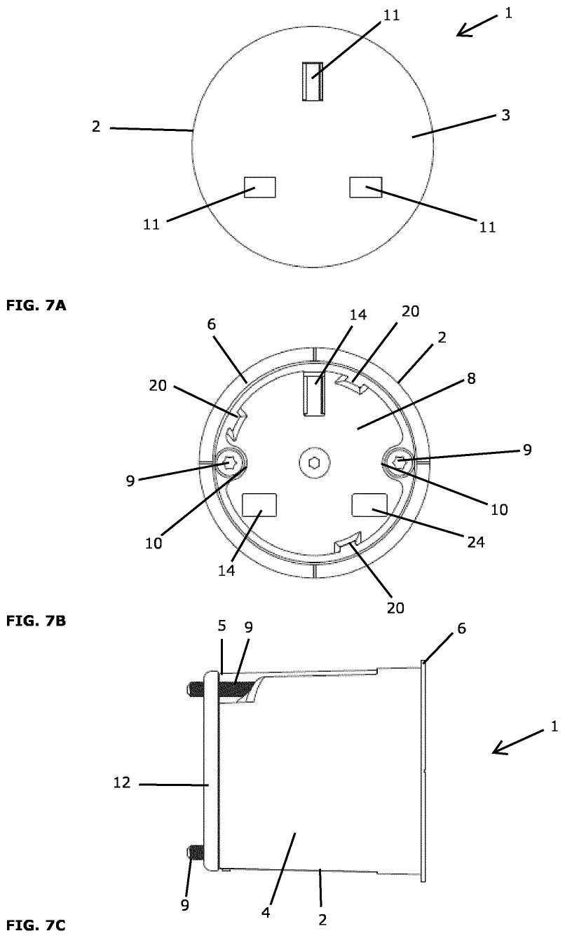

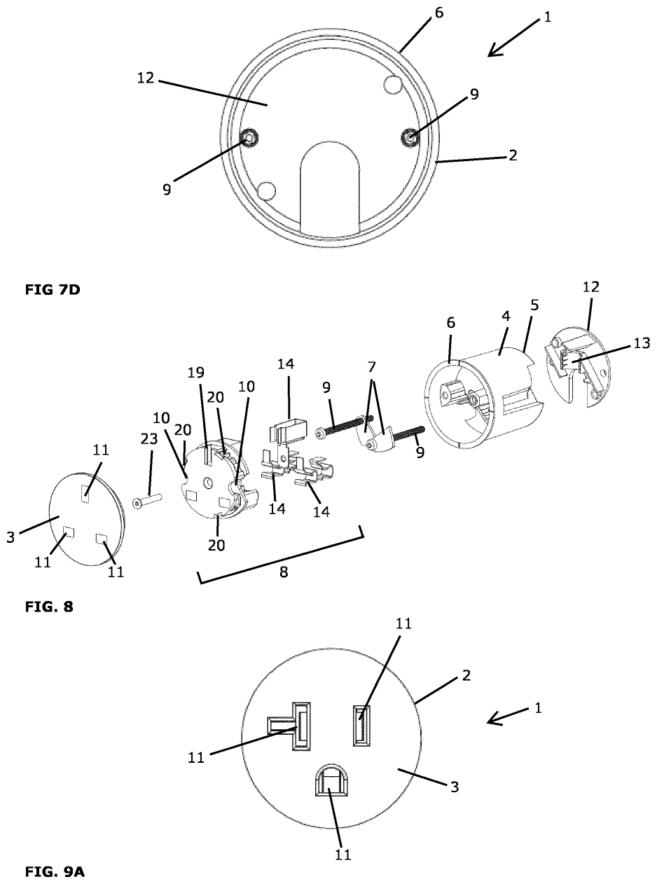

FIGS. 7A-7D show a front view, a front view without a front wall, a side view and a rear view of a flush-mounted module according to an alternative embodiment of the present invention with a type G socket according to the IEC 60083:2015 standard.

This alternative embodiment is very similar to the flush-mounted module (1) from FIGS. 5A-5D. The first major difference is that the front wall (3) is attached to the socket (8) using a bayonet connector (20). In addition, in this embodiment a cover (12) is also attached to the back wall (5) of the housing (2). The clamp screws (9) are placed on a circular outline with a diameter of 34.2 mm. This is within an enveloping circle of the smallest possible insulation surface for a socket (8) of type G, where there must be at least 3 mm of insulation material around the contact points (14). The housing (2) is cylindrical with an inner diameter of 41 mm. The front wall (3) is also circular and has a diameter of 49 mm. The flange (6) has a diameter of 46.8 mm. The flange (6) is incorporated in a recess in the rear of the front wall (3). The flush-mounted module (1) can be placed in a cylindrical space with a diameter of 44 mm.

FIG. 8 shows an exploded view of the flush-mounted module from FIGS. 7A-7D.

The exploded view shows how the contact points (14) and the clamps (7) have been adapted compared to the embodiment in FIGS. 5A-5D. The cover (12) with strain relief is now also more clearly visible. A smaller change is that the socket is attached to the housing with a screw (23).

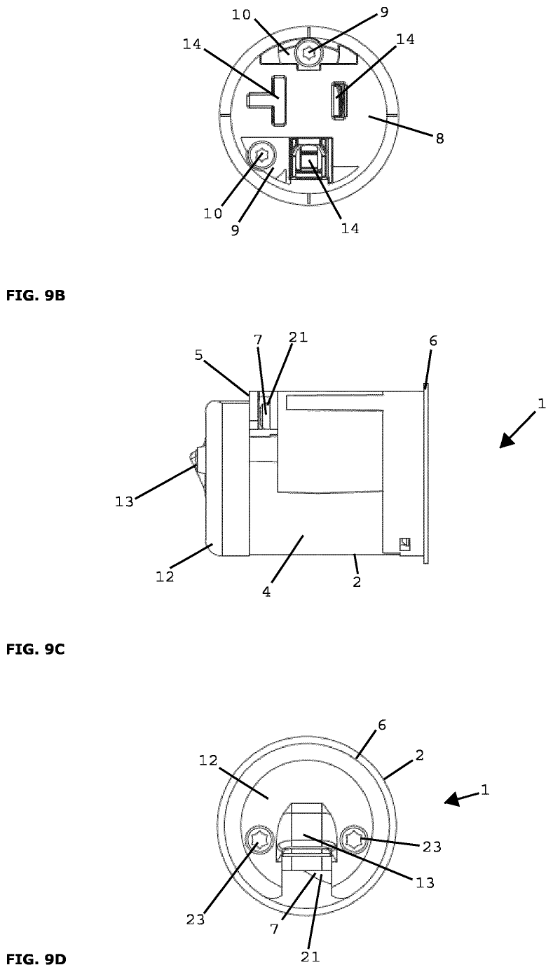

FIGS. 9A-9D show a front view, a front view without a front wall, a side view and a rear view of a flush-mounted module according to an embodiment of the current invention with a type B socket according to the IEC 60083:2015 standard.

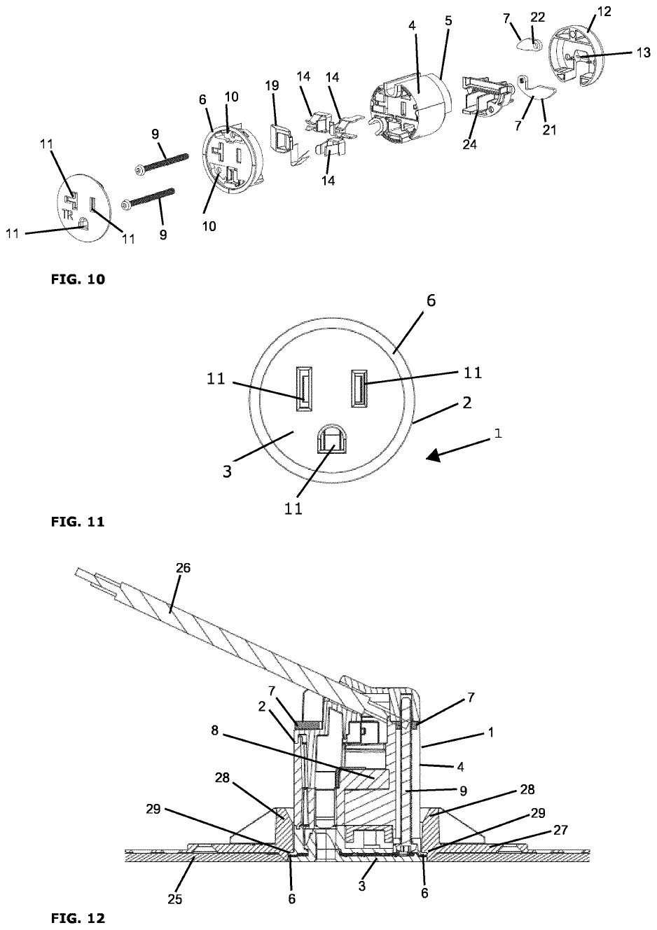

The flush-mounted module (1) has a similar structure to the flush-mounted modules (1) from the previous figures of type G. The main difference is that the socket (8) is type B. Such a socket (8), like a socket of type G, does not require the front wall (3) to be recessed. The front wall (3) is removably clicked onto the socket (8) and still covers the clamp screws (9). The socket (8) is screwed into the housing (2). This is more clearly visible in FIG. 10. The front wall (3) is flat and positioned on the flange (6). The front wall (3) thus conceals the flange (6). In this embodiment the flange (6) is not a visible surface and does not have to be finished so accurately. The socket (8) has recesses (10) so that the clamp screws (9) can again be reached with a screwdriver. The clamp screws (9) are not covered by the socket (8). The clamp screws (9) are placed on a circular outline with a diameter of 26 mm. The mentioned circular outline is concentric with the flange (6). This is within an enveloping circle of the smallest possible insulation surface for a type B socket (8). The enveloping circle for the smallest possible insulation surface for the type B socket fits within a cylindrical space with an internal diameter of 36.5 mm±3 mm. In this embodiment, the cylindrical space has an inner diameter of 35 mm. The flush-mounted module (1) contains two clamps (7). The two clamps (7) can be moved along the hollow body to the plane formed by the flange (6) by screwing their clamp screw (9). The two clamps (7) can be moved from a folded in position to a folded out position. Viewed in a plane parallel to the plane formed by the flange (6), a first (21) of the two clamps (7) extends from the clamp screw (9) of the first clamp (21) over a greater distance than a second (22) of the two clamps (7) extends from the clamp screw (9) of the second clamp (22). The first clamp (21) extends in an arc shape from the clamp screw (9) of the first clamp (21). A central angle of a circular arc on said circular outline having as endpoints centerlines of the clamp screws (9) of the first clamp (21) and the second clamp (22) is 135°. The central angle is the angle determined by a center of the said circular outline as a vertex, a line through the centerline of the clamp screw (9) of the first clamp (21) and a line through the centerline of the clamp screw (9) of the second clamp (22). The housing (2) is cylindrical with an inner diameter of 33.3 mm. The front wall (3) is also circular and has a diameter of 37.9 mm. The front wall (3) covers the flange (6) of the housing (1). The flange (6) is circular and has the same diameter of 37.9 mm. A cover (12) is attached to the back wall (5) of the housing (2).

FIG. 10 shows an exploded view of the flush-mounted module from FIGS. 9A-9D.

FIG. 10 clearly shows how the clamp screws (9) are positioned in recesses (10) in the socket (8). The cover (12), which provides strain relief on a cable, is also clearly shown. The socket (8) comprises spacers for screwing the socket (8) into the housing (2) using screws (23). The contact points (14) are held between the socket (8) and an accessory (24) in the housing (2). The cover (12) is screwed to the back wall (5).

FIG. 11 shows a front view of a flush-mounted module according to an alternative embodiment of the present invention with a type B socket according to the IEC 60083:2015 standard.

A first difference with the embodiment in FIGS. 9A-9D is that the front wall (3) of this flush-mounted module (1) is suitable for type B sockets (8) up to a maximum current of 15 A. A second difference is that in this case the front wall (3) is placed concentrically within the flange (6). It will be apparent to a person skilled in the art that this embodiment can also be implemented in a 20 A version, just as the embodiment in FIGS. 9A-9D can be implemented in a 15 A version.

FIG. 12 shows a cross-section of a flush-mounted module according to an embodiment of the current invention, wherein the flush-mounted module is placed in a wall with the aid of a mounting plate.

The flush-mounted module (1) is very similar to the flush-mounted module (1) from FIGS. 9A-9D and FIG. 10. In FIG. 12, a cable (26) is already provided for the flush-mounted module (1). The flush-mounted module (1) is placed in a round opening in a wall (25). In this embodiment, a mounting plate (27) is placed on a front side of the wall (25). The mounting plate (27) comprises a cylindrical wall (28) that extends on the mounting plate (27). The cylindrical wall (28) has an open base surface and an open top surface. The mounting plate (27) is plastered on a front side of the mounting plate (27) up to the open base surface of the cylindrical wall (28). FIG. 12 shows only a layer of plaster on the front side of the mounting plate (27) of the hollow wall (22). It will be apparent that a rear side of the mounting plate (27) is placed on, for example, board material of the hollow wall (22). The board material is not shown in FIG. 12. The cylindrical wall (28) bounds a cylindrical space. The cylindrical space extends through the round opening in the wall (25) to the rear side of the wall (25). The flush-mounted module (1) is placed into the cylindrical space through the round opening in the wall (25). After screwing down the clamps (7), the clamps (7) clamp against the cylindrical wall (28). In FIG. 12 the clamps (7) have not yet been screwed down. The mounting plate (27) comprises a recess (29). The flange (6) of the flush-mounted module (1) is incorporated in the recess (29).

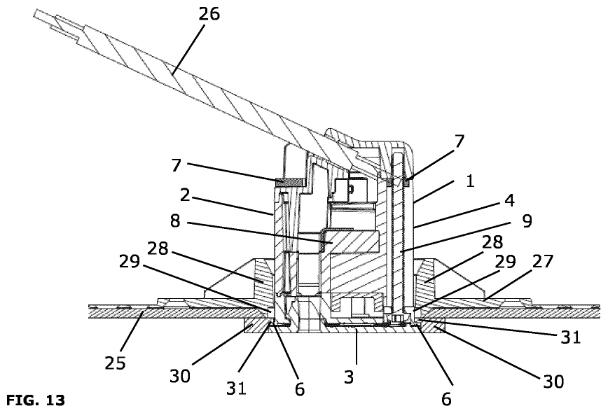

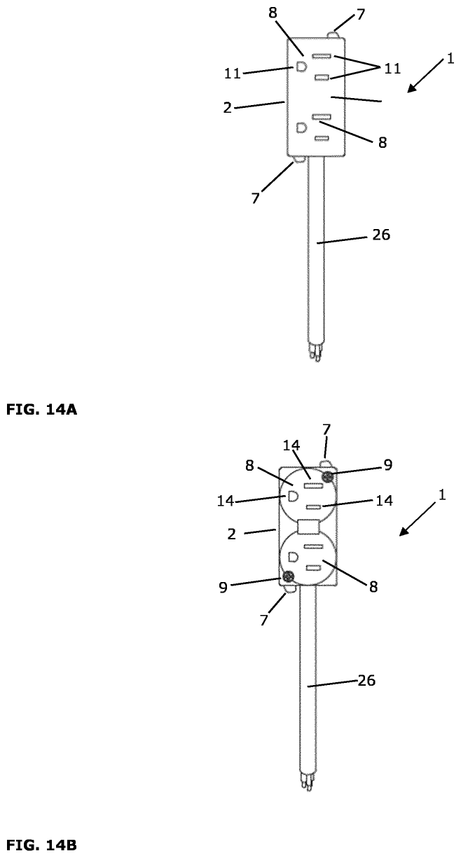

FIG. 13 shows a cross-section of a flush-mounted module according to an alternative embodiment of the current invention, wherein the flush-mounted module is placed in a wall with the aid of a mounting plate and wherein a releasable ring is clamped between the wall and a flange of the flush-mounted module.

This embodiment is very similar to the embodiment in FIG. 12. The big difference is that in this embodiment a removable ring (30) is clamped between the wall (25) and the flange (6) of the flush-mounted module (1). The removable ring (30) has a recess (31) on an inner outline. The flange (6) is accommodated in the recess (31). The removable ring (30) covers an edge of the opening in the wall (25).

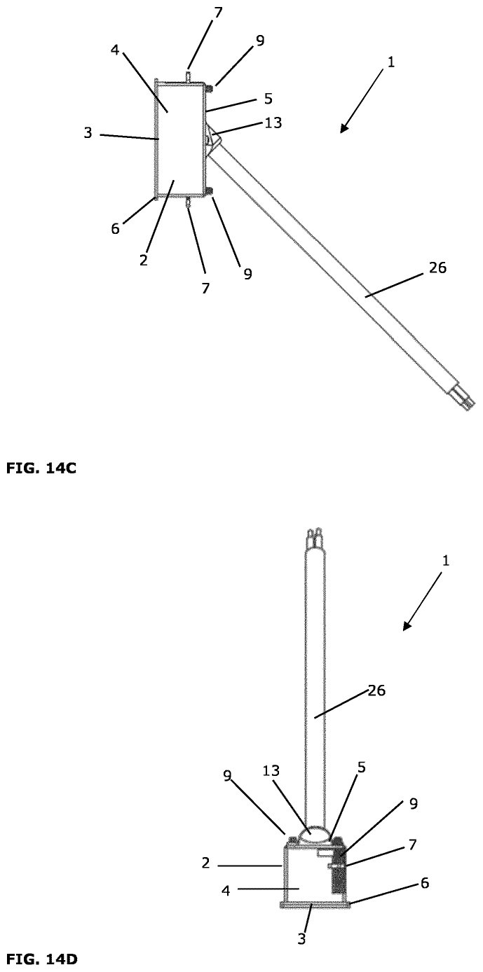

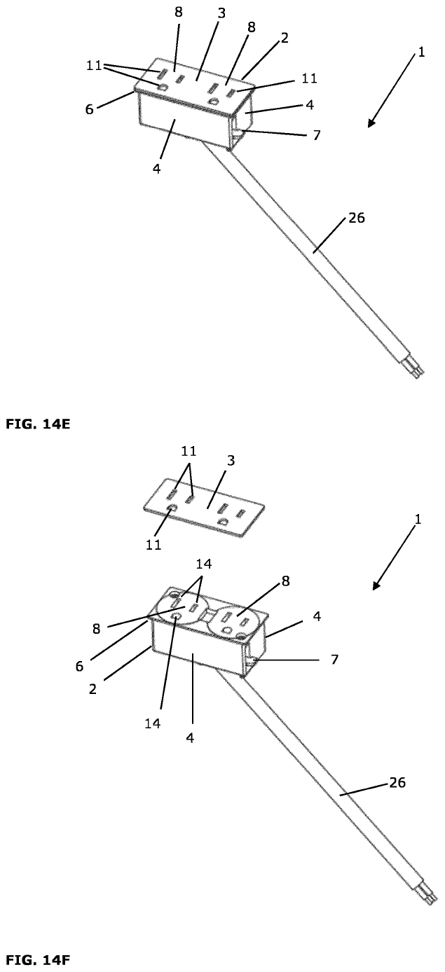

FIG. 14A-14G shows a front view, a front view without a front wall, a side view, a top view, a perspective view, a perspective view without a front wall, and a perspective rear view of a flush-mounted module according to an embodiment of the current invention with two type B sockets in a horizontal arrangement.

The flush-mounted module (1) comprises two sockets (8) of type B according to the IEC 60083:2015 standard. The housing (2) is in this embodiment beam-shaped. The housing (2) comprises a clamp (7) at each short side of a rectangle. The rectangle is a smallest possible rectangle around each enveloping outline of a smallest possible insulation surface around the contact points (14) of each individual socket (8). After perpendicular projection onto the plane formed by the flange (6), a center point of the clamp screws (9) of the two clamps (7) lies within the rectangle. The rectangle has in this embodiment a length of 66.8 mm and a width of 33.3 mm. In this particular embodiment, the center point of the clamp screws (9) each lie within the enveloping outline of a socket (8). The clamp screws (9) can be reached with a screwdriver through a recess in the corresponding socket (8). The clamps (7) are of a similar type as in the previous figures. The front wall (3) of the housing (2) is removable. The front wall (3) covers the clamp screws (9). The front wall (3) is positioned on the flange (6). The front wall (3) hides the flange (6). The housing (2) comprises a guide (13) for an electrical cable (26), similar to the guide in FIG. 9C.

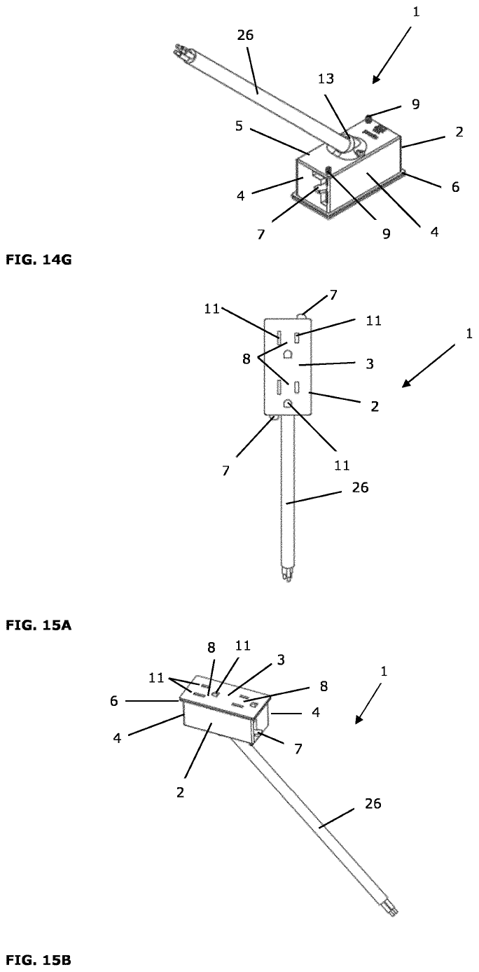

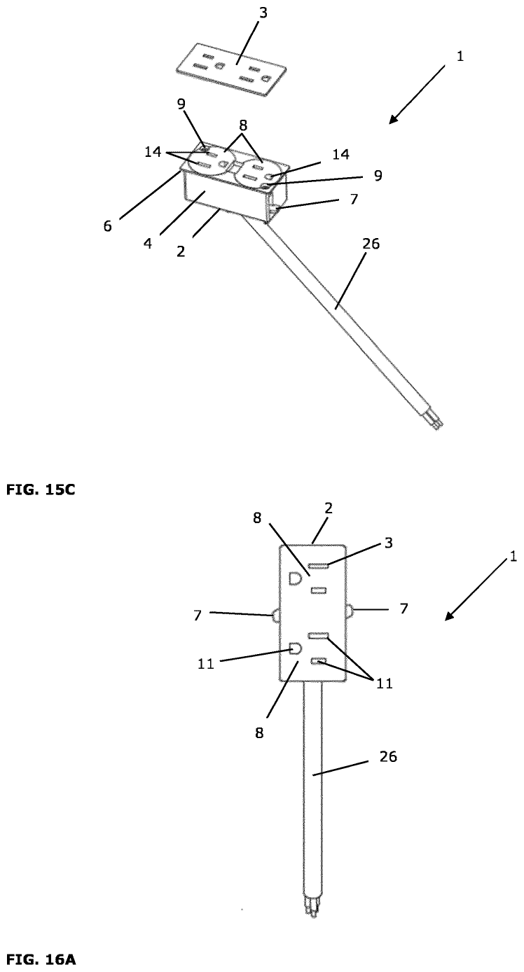

FIG. 15A-15C shows a front view, a perspective view, and a perspective view without a front wall of a flush-mounted module according to an embodiment of the current invention with two type B sockets in a vertical arrangement.

The flush-mounted module (1) is almost identical to the flush-mounted module (1) from FIGS. 14, with as main difference that the two sockets (8) are vertically aligned.

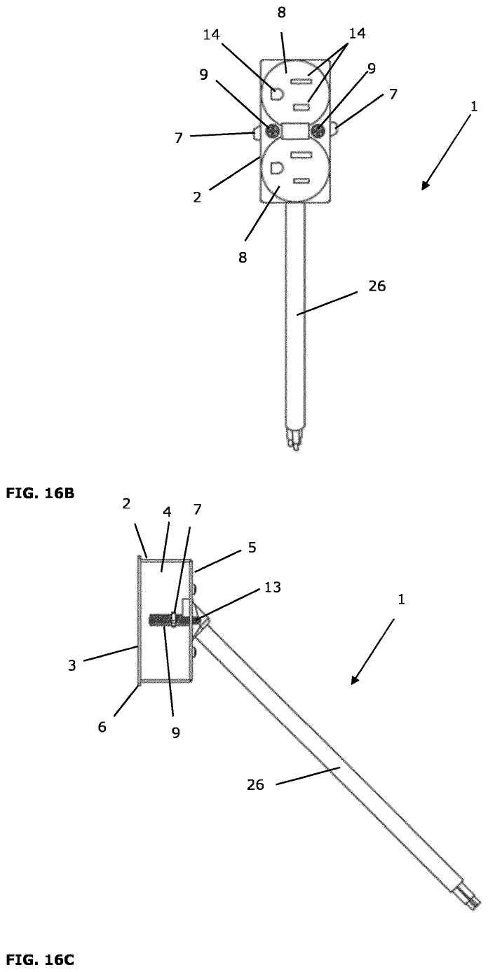

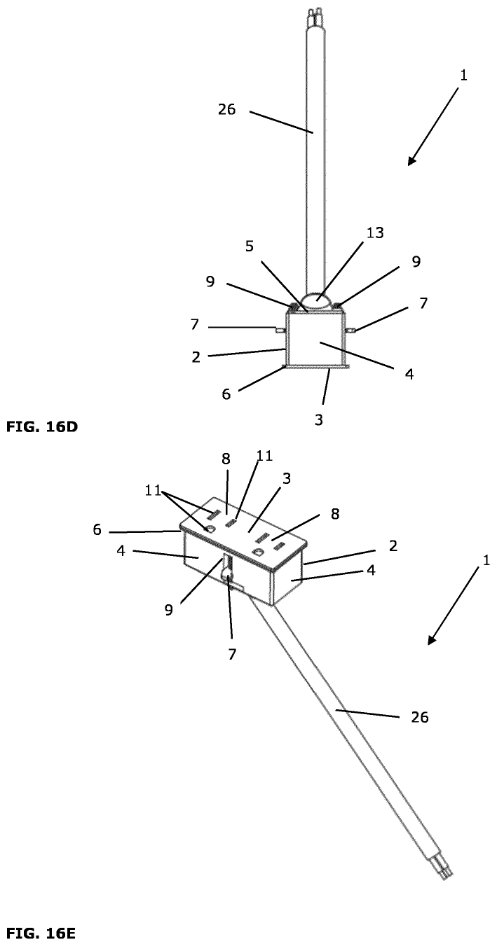

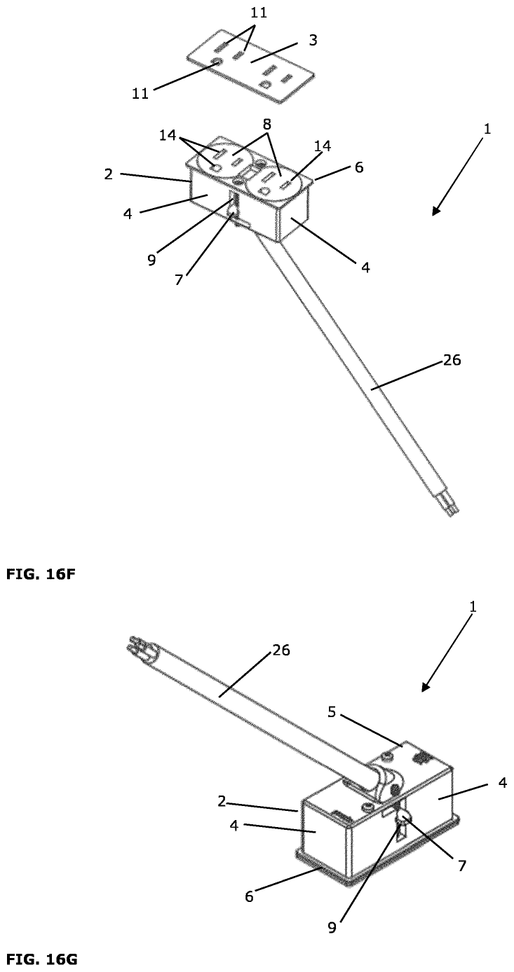

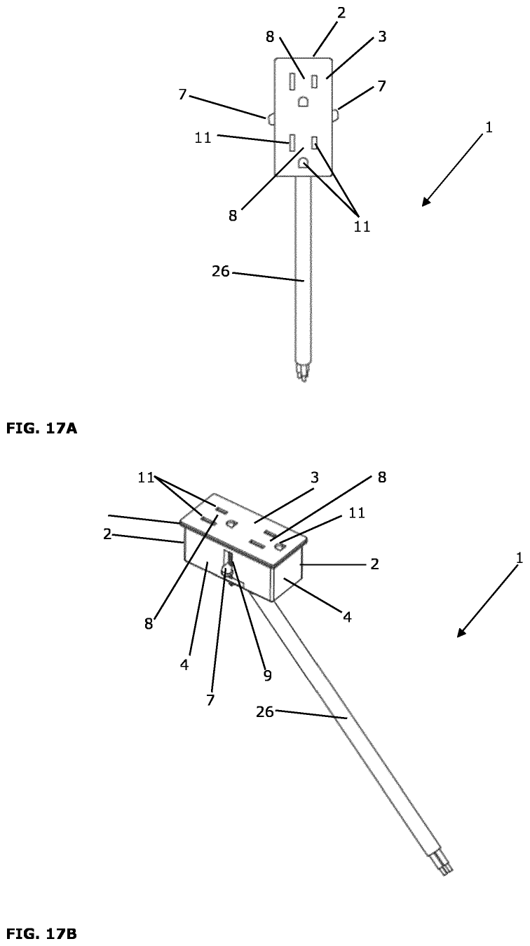

FIG. 16A-16G shows a front view, a front view without a front wall, a side view, a top view, a perspective view, a perspective view without a front wall, and a perspective rear view of a flush-mounted module according to an embodiment of the current invention with two type B sockets in a horizontal arrangement.

The flush-mounted module (1) is almost identical to the flush-mounted module (1) from FIG. 14. A first importance difference is that the housing (2) comprises a clamp (7) at each long side of the rectangle, instead of at each short side. The clamp screws (9) are positioned in the middle of the corresponding long side. A second difference is that the center point of the clamp screws (9) do not lie within the enveloping outline of a socket (8). The center point of the clamp screws (9) of the two clamps (7) lies within an oval area, bounded by a semicircle part of the enveloping outline of a first socket (8), a semicircle part of the enveloping outline of a second socket (8) and two parallel lines connecting the semicircles.

FIG. 17A-17C shows a front view, a perspective view, and a perspective view without a front wall of a flush-mounted module according to an embodiment of the current invention with two type B sockets in a vertical arrangement.

The flush-mounted module (1) is almost identical to the flush-mounted module (1) from FIG. 16 with as main difference that the two sockets (8) are vertically aligned.

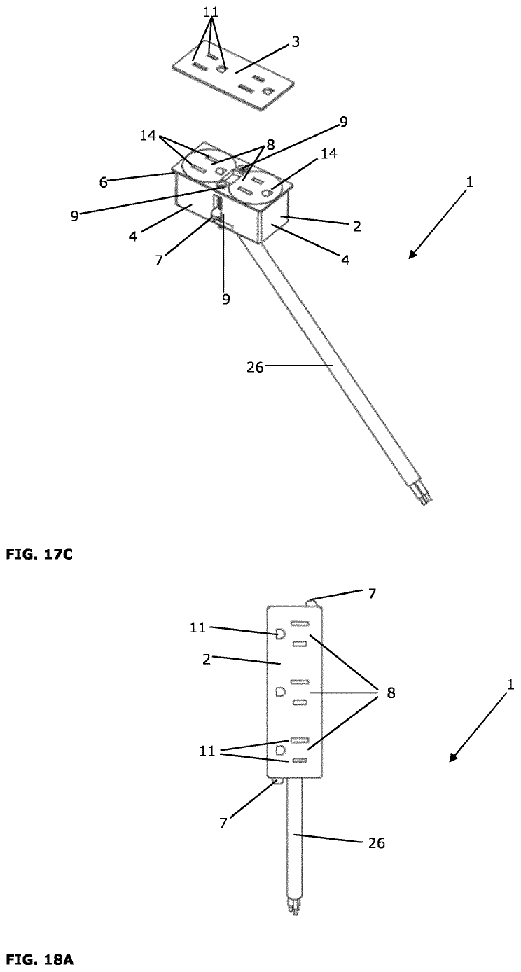

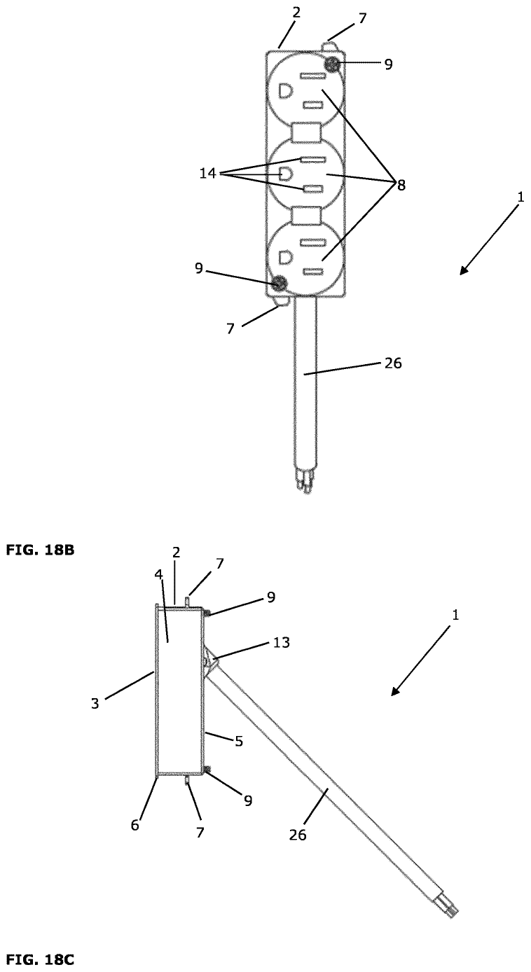

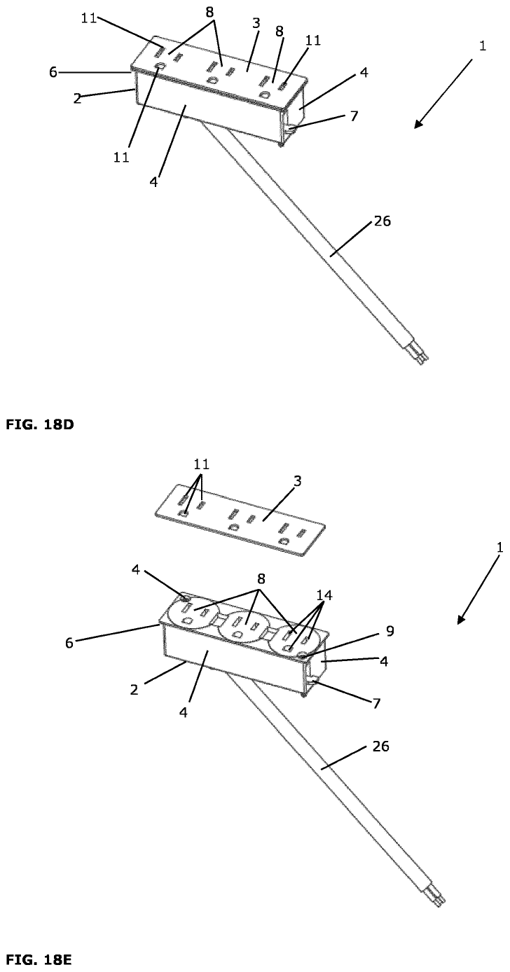

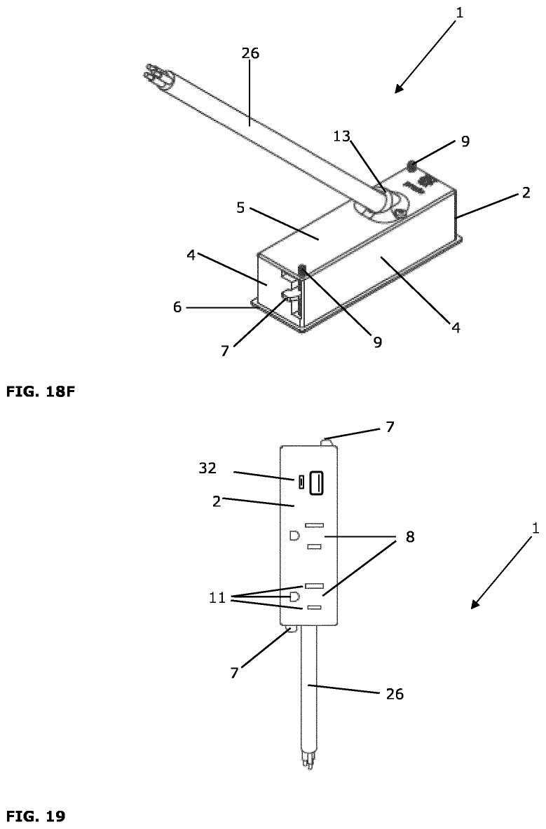

FIG. 18A-18F shows a front view, a front view without a front wall, a side view, a perspective view, a perspective view without a front wall, and a perspective rear view of a flush-mounted module according to an embodiment of the current invention with three type B sockets in a horizontal arrangement.

The flush-mounted module (1) is almost identical to the flush-mounted module (1) from FIGS. 14, with as main difference that the housing (2) comprises three sockets (8). The rectangle has in this embodiment a length of 100.2 mm and a width of 33.3 mm. Remark that also in this embodiment the center point of the clamp screws (9) each lie within the enveloping outline of a socket (8).

FIG. 19 shows a front view of a flush-mounted module according to an embodiment of the current invention with two type B sockets and a USB-port in horizontal arrangement.

The flush-mounted module (1) is almost identical to the flush-mounted module (1) from FIGS. 18, with as main difference that the housing (2) comprises two sockets (8) and one additional electrical base element. The additional electrical base element (32) is a single USB A-connector and a single USB C-connector. After perpendicular projection onto the plane formed by the front wall (3), the additional electrical base element (32) lies within a circle that has a diameter that is equal to a diameter of the enveloping outlines of the smallest possible insulation surface around the contact points (14) of the two sockets (8). The rectangle that in the flush-mounted module (1) of FIG. 18 was the smallest possible rectangle around each enveloping outline of the smallest possible insulation surface around the contact points of each individual socket (8), is now the smallest possible rectangle around each enveloping outline of each individual socket (8) and around the circle wherein the additional electrical base element (32) lies. With other words, a socket (8) and an additional electrical base element (32) can be exchanged without changing the dimensions of the flush-mounted module.

The numbered elements in the figures are:
1. Flush-mounted module
2. Housing
3. Front wall
4. Side wall
5. Back wall
6. Flange
7. Clamp
8. Socket
9. Clamp screw
10. Clamp screw recess
11. Contact point opening
12. Cover
13. Guide
14. Contact point
15. Nut
16. Bolt
17. Curved surface
18. Hinged arm
19. Child safety device
20. Bayonet connector
21. First clamp
22. Second clamp
23. Screw
24. Accessory
25. Wall
26. Cable
27. Mounting plate
28. Cylindrical wall
29. Recess in mounting plate
30. Removable ring
31. Recess in the removable ring
32. Additional electrical base element.

1. A flush-mounted module for flush mounting of a socket in a wall or a piece of furniture, comprising a housing and a socket, wherein the housing comprises a hollow body with a front wall, back wall and one or more side walls, wherein the housing comprises a flange on a side of the front wall, wherein the flange extends in a direction away from the hollow body, wherein the hollow body can be placed in a space in the wall or in the piece of furniture up to the flange, wherein the housing comprises at least one clamp for clamping the flush-mounted module in the wall or in the piece of furniture and a clamp screw through each of the at least one clamp, wherein the socket is mounted behind the front wall in the housing and wherein the front wall includes openings to contact points of the socket, characterized in that, after perpendicular projection onto a plane formed by the front wall, a center point of the clamp screw of the at least one clamp lies within a polygon, wherein the polygon has a number of sides, wherein the polygon is a smallest possible polygon with said number of sides around an enveloping outline of a smallest possible insulation surface around the contact points of the socket, wherein an enveloping outline is a smallest possible circle in the plane formed by the front wall around the smallest possible insulation surface.

2. The flush-mounted module according to claim 1, characterized in that the flush-mounted module further comprises one or more sockets and at least one additional electrical base element, different from a socket, wherein after perpendicular projection onto the plane formed by the front wall, the additional electrical base element lies within a circle, wherein the circle has a diameter that is equal to a diameter of the enveloping outlines of the smallest possible insulation surface around the contact points of the one or more sockets, and wherein the rectangle is a smallest possible rectangle around each enveloping outline of each individual socket of the one or more sockets and around said circle.

3. The flush-mounted module according to claim 1, characterized in that the flush-mounted module comprises at least two sockets, wherein the at least two sockets are mounted behind the front wall in the housing, wherein after perpendicular projection onto the plane formed by the front wall, a center point of the clamp screw of the at least one clamp lies within a rectangle, wherein the rectangle is a smallest possible rectangle around each enveloping outline of the smallest possible insulation surface around the contact points of each individual socket, wherein an enveloping outline is a smallest possible circle in the plane formed by the front wall around the smallest possible insulation surface.

4. The flush-mounted module according to claim 3, characterized in that the center point of the clamp screw of the at least one clamp lies within an oval area, bounded by a semicircle part of the enveloping outline of a first socket, a semicircle part of the enveloping outline of a second socket and two parallel lines connecting the semicircles.

5. The flush-mounted module according to claim 2, characterized in that a clamp is placed on each short side of the rectangle.

6. The flush-mounted module according to claim 2, characterized in that a clamp is placed on each long side of the rectangle.

7. The flush-mounted module according to claim 3, characterized in that the at least two sockets are electrically interconnected.

8. The flush-mounted module according to claim 1, characterized in that the front wall is circular with a diameter of 39 mm±1 mm or in that there is a circular recess in the front wall with an inner diameter of 39 mm±1 mm, wherein the clamp screw of the at least one clamp is placed on a circular outline with a diameter of no more than 36 mm and where the circular outline and the front wall are concentric.

9. The flush-mounted module according to claim 8, characterized in that the hollow body can be placed in a cylindrical space up to the flange, wherein the cylindrical space has an inner diameter of 42 mm±3 mm.

10. The flush-mounted module according to claim 1, characterized in that the space in the wall or in the piece of furniture is cylindrical, wherein the cylindrical space has an inner diameter of 44 mm±4 mm, wherein the clamp screw of the at least one clamp is placed on a circular outline with a diameter of no more than 36 mm and wherein the circular outline and the cylindrical space are concentric.

11. The flush-mounted module according to claim 1, characterized in that the space is cylindrical, wherein the cylindrical space has an inner diameter of 36.5 mm±3 mm.

12. The flush-mounted module according to claim 11, characterized in that the clamp screw of the at least one clamp is placed on a circular outline with a diameter of no more than 28.5 mm and wherein the circular outline and the cylindrical space are concentric.

13. The flush-mounted module according to claim 9, characterized in that the flange is circular, wherein the flange and the cylindrical space are concentric, wherein the flange has a radius that is at least 1 mm and at most 5 mm greater than a radius of the cylindrical space.

14. The flush-mounted module according to claim 1, characterized in that the center point of the clamp screw of the at least one clamp lies within an enveloping outline of the socket, wherein the clamp screw of the at least one clamp can be reached with a screwdriver through a recess in the corresponding socket.

15. The flush-mounted module according to claim 1, characterized in that the front wall has an opening, wherein the clamp screw of the at least one clamp can be reached with a screwdriver through the opening in the front wall.

16. The flush-mounted module according to claim 1, characterized in that the front wall is removable, wherein the front wall covers the clamp screw of the at least one clamp.

17. The flush-mounted module according to claim 16, characterized in that the front wall is positioned recessed in the hollow body, with a gap of at most 1.5 mm between an outline of the front wall and the hollow body, where the gap is measured in a plane parallel to the plane formed by the front wall and perpendicular to the outline of the front wall and where the flange forms a visible surface.

18. The flush-mounted module according to claim 16, characterized in that the front wall is positioned on the flange, with the front wall hiding the flange.

19. A method for flush mounting a socket in a wall or in a piece of furniture, comprising:
providing a flush-mounted module comprising a housing and a socket, wherein the housing comprises a hollow body with a front wall, back wall, one or more side walls, a flange, at least one clamp for clamping the flush-mounted module in the wall or in the piece of furniture and a clamp screw through each of the at least one clamp, wherein the socket is mounted behind the front wall in the housing and wherein the front wall includes openings to contact points of the socket;
making an opening for the flush-mounted module in the wall or in the piece of furniture;
connecting the flush-mounted module to cabling in the wall or in the piece of furniture;
placing the flush-mounted module in the opening in the wall or the piece of furniture, wherein the hollow body is positioned through the opening in the wall or in the piece of furniture and wherein the flange leans against the wall or the furniture;
tightening the clamp screw of the at least one clamp to clamp the flush-mounted module in the opening;
characterized in that a flush-mounted module according to claim 1 is used.

20. The method according to claim 19, characterized in that the front wall is removed before placing the flush-mounted module in the opening in the wall or in the piece of furniture, wherein the method further includes placing the front wall after tightening the clamp screw of the at least one clamp, wherein the front wall covers the clamp screw of the at least one clamp.
